(19) United States
(12) Patent Application Publication
(10) Pub. No.: US 2026/0044806 A1
(43) Pub. Date: Feb. 12, 2026

(54) SYSTEMS AND METHODS FOR UTILIZING TRACKING DATA FOR PREDICTING PLAYER RATINGS

(71) Applicant: STATS LLC, Chicago, IL (US)

(72) Inventors: Matthew Joseph SCOTT, Chicago, IL (US); Lucas Alexander HAUPT, Chicago, IL (US); Isabella SAMPER, Richmond, VA (US); Evan Nicholas BOYD, Chicago, IL (US); Trevor GOLDSTEIN, Cupertino, CA (US)

(73) Assignee: STATS LLC, Chicago, IL (US)

(21) Appl. No.: 19/292,430

(22) Filed: Aug. 6, 2025

Related U.S. Application Data
(60) Provisional application No. 63/680,427, filed on Aug. 7, 2024.
(60) Provisional application No. 63/736,337, filed on Dec. 19, 2024.
(60) Provisional application No. 63/743,507, filed on Jan. 9, 2025.

(51) Int. Cl. G06Q 10/0639

(52) U.S. Cl. CPC G06Q 10/06398

(57) ABSTRACT

Disclosed techniques relate to utilizing tracking data for predicting player ratings. In an example, a method for utilizing tracking data to predict a player rating includes receiving broadcast data for a plurality of games in a first league, the plurality of games including a first player, generating tracking data for each of the plurality of games, the tracking data comprising coordinates of player positions and ball positions for each frame of the broadcast data, receiving play-by-play data for each of the plurality of games, the play-by-play data describing events that occur within the plurality of games, merging the tracking data and play-by-play data to generate a set of input features, and predicting, based on the set of input features, a player rating for the first player, the player rating being indicative of a predicted level of performance in a second league.

### CROSS-REFERENCE TO RELATED APPLICATIONS

This application claims the benefit of priority to U.S. Provisional Patent Application No. 63/680,427, filed on Aug. 7, 2024, the entirety of which is incorporated herein by reference. This application also claims the benefit of priority to U.S. Provisional Patent Application No. 63/743,507, filed on Jan. 9, 2025, the entirety of which is incorporated herein by reference. This application also claims the benefit of priority to U.S. Provisional Patent Application No. 63/736,337, filed on Dec. 19, 2024, the entirety of which is incorporated herein by reference.

### TECHNICAL FIELD

Various embodiments of the present disclosure relate generally to machine learning for sports applications, and, more particularly, to systems and methods for utilizing tracking data to predict a player rating. Various embodiments of the present disclosure relate generally to generating automated player performance ratings and, more particularly, to systems and methods for generating daily-updated rating of individual player performance in sports.

### INTRODUCTION

Professional sports commentators and fans alike typically engage in what-if scenarios for players. For example, a common thread in sports media focuses on how a college player or international player may translate to a professional league such as the National Basketball Association (“NBA”). It may be valuable to predict performance of a player in a second league based on analysis of the player in a first league. In another example, another thread in sports media focuses on what-if discussions or debates regarding who is the best player of their generation or who is the best player in a certain category of statistics. It may further be valuable to identify data and/or metrics related to a player's performance, for example, over a period of time.

As the amount of data related to sports increases, teams, fans, and companies alike strive to find a metric that adequately captures the impact of a player for their given team. While for some users, such as teams, coaches, and trainers, such metrics are critical to their team's performance, other user's such as fans may utilize the information to engage in what-if discussions or debates regarding who is the best player of their generation or who is the best player in a certain category of statistics.

Unless otherwise indicated herein, the techniques and information described in this section are not prior art to the claims in this application and are not admitted to be prior art, or suggestions of the prior art, by inclusion in this section.

### SUMMARY

In some aspects, techniques described herein relate to a method relate to a method for utilizing tracking data to predict a player rating, the method comprising: receiving broadcast data for a plurality of games in a first league, the plurality of games including a first player; generating tracking data for each of the plurality of games, the tracking data comprising coordinates of player positions and ball positions for each frame of the broadcast data; receiving play-by-play data for each of the plurality of games, the play-by-play data describing events that occur within the plurality of games; merging the tracking data and play-by-play data to generate a set of input features; and predicting, based on the set of input features, a player rating for the first player, the player rating being indicative of a predicted level of performance in a second league.

In some aspects, techniques described herein relate to a system for utilizing tracking data to predict a player rating, the system comprising: a memory configured to store processor-readable instructions; and a processor operatively connected to the memory, and configured to execute the instructions to perform operations comprising: receiving broadcast data for a plurality of games in a first league, the plurality of games including a first player; generating tracking data for each of the plurality of games, the tracking data comprising coordinates of player positions and ball positions for each frame of the broadcast data; receiving play-by-play data for each of the plurality of games, the play-by-play data describing events that occur within the plurality of games; merging the tracking data and play-by-play data to generate a set of input features; and predicting, based on the set of input features, a player rating for the first player, the player rating being indicative of a predicted level of performance in a second league.

In some aspects, techniques described herein relate to a method for determining a performance rating of a target player, the method comprising: identifying, by a computing system, the target player; receiving broadcast data for a plurality of game, the plurality of games including the target player; generating tracking data for each of the plurality of games, the tracking data comprising coordinates of a position of the target player and ball positions for each frame of the broadcast data; receiving play-by-play data for each of the plurality of games, the play-by-play data describing events related to the target player that occur within the plurality of games; generating, by the computing system, time series data points for the target player based on the tracking data and play-by-play data of the target player; providing, by the computing system, an input including the time series data points to a first player prediction model and a second player prediction model, wherein the first and the second player prediction models are trained to find associations between the first game data of a plurality of other players and the time series data points of the target player and output a next game projection for the target player; generating, by the first and second player prediction models, the next game projection for the target player; generating, by the computing system, an adjustment weighting, wherein the adjustment weighting is based on a comparison of the next game projection for the target player with an average statistic for the target player; providing, by the computing system, the adjustment weighting to the first and the second player prediction models as training data; and training, by the computing system, the first and the second player prediction models using the training data.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2A is a block diagram illustrating aspects of the prediction system of FIG. 1, according to example embodiments.

FIG. 2B is a block diagram of a set of models within the prediction system of FIG. 1, according to example embodiments.

FIG. 3 is a flowchart for predicting a player rating, according to example embodiments.

FIG. 4 is a flowchart for implementing one or more models to predict a player rating, according to example embodiments.

FIG. 5A is a flow diagram illustrating a method of predicting a range of draft positions for a draft eligible player, according to example embodiments.

FIG. 5B is a flow diagram illustrating a method of predicting player performance in a second league for a player from a first league, according to example embodiments.

FIG. 6A illustrates exemplary statistics from player tracking data collected from international events for a first player, according to one or more embodiments.

FIG. 6B illustrates exemplary statistics from player tracking data collected from international events for a second player, according to one or more embodiments.

FIG. 7 depicts a flow diagram illustrating a method of generating DRIP (Daily Updated Rating of Individual Performance) values for a player, according to example embodiments.

FIGS. 8A and 8B depict exemplary flow diagrams illustrating a generation of DRIP values for a player, according to one or more embodiments.

FIGS. 8C-81 depict exemplary input and output values for generating a DRIP value for a player, according to one or more embodiments.

FIG. 9A depicts an exemplary flow diagram illustrating a generation of DRIP values for a player, according to one or more embodiments.

FIGS. 9B and 9C depict exemplary input and output values for generating a DRIP value for a player, according to one or more embodiments.

FIGS. 9D and 9E depict exemplary outputs, according to example embodiments.

FIG. 9F depicts an exemplary VAPR graphic, according to example embodiments.

FIGS. 9G and 9H depict exemplary outputs, according to example embodiments.

FIGS. 10A and 10B illustrate exemplary DRIP values for multiple players, according to one or more embodiments.

FIG. 11 illustrates an exemplary snapshot of the player tracking and markings detected from the broadcast tracking system, according to one or more embodiments.

FIG. 12 illustrates an exemplary chart corresponding to the Shapley values generated for a first player using raw data and padded data, according to example embodiments.

FIG. 13 illustrates an exemplary chart corresponding to a draft talent bin prediction for a second player, according to example embodiments.

FIG. 14 illustrates an exemplary distribution of observations for each class and each set of bins, according to one or more embodiments.

FIGS. 15A and 15B illustrate exemplary drafting prediction graphs, according to one or more embodiments.

FIG. 16 illustrates an exemplary output of DRIP values expressed as DRIP rating, according to one or more embodiments.

FIG. 17 illustrates an exemplary bar chart that tracks the mean squared error (MSE) for offensive and defensive DRIP values, according to one or more embodiments.

FIG. 18 illustrates a line graph that tracks the R2 score for an offensive DRIP, according to one or more embodiments.

FIG. 19 illustrates a player's career ranks based on the defensive DRIP and how the model performed, according to one or more embodiments.

FIG. 20 depicts a flow diagram for training a machine-learning model, according to example embodiments.

FIG. 21A is a block diagram illustrating a computing device, according to example embodiments.

FIG. 21B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The field of sports analytics has grown exponentially over the years as access to finer grained player data in the world of professional sports in the United States, and internationally, has become easier. However, while professional sports leagues have the revenue to install state-of-the-art optical player and ball tracking systems in select arenas and/or stadiums, such wide-spread adoption is not present in certain (e.g., non-professional) sports leagues. For example, for basketball, select National Basketball Association (“NBA”) arenas may have an optical player and ball tracking system deployed therein; however, colleges and universities in the National Collegiate Athletic Association (“NCAA”), teams in the NBA development league (i.e., the G-league), and international leagues (e.g., Liga ACB in Spain, Chinese Basketball Association, Basketball Champions League, and the like) may not have the revenue or ability to deploy optical player and ball tracking systems in the arenas those teams occupy. For example, in-venue hardware solutions are simply impractical for the NCAA, with over 300 Division I schools alone in addition to the numerous exhibitions, tournaments, and post-season games not played at NCAA venues. Such limitations impact the NBA, for example, such that NBA teams are severely limited in their decision-making ability for an upcoming draft or other selection process due to the lack of detailed tracking data of draft-eligible players from these leagues. Additionally, this limitation is compounded by the fact that in-venue optical player and ball tracking systems are a newer phenomenon. As such, it is difficult for an NBA front office to accurately model a potential player's (e.g., a college player's) future potential output, as there is a lack of historical tracking data for current or past NBA players to build a training set for modeling.

To account for this limitation, one or more techniques described herein utilize state-of-the-art computer vision techniques to capture player and ball tracking data from thousands of historical non-NBA games (e.g., NCAA D-I Men's basketball games) directly from broadcast video. The volume of such data may equate to more than 650,000 possessions and over 300 million frames of broadcast video, for example. From the tracking data, the one or more techniques described herein automatically detect events, such as, but not limited to, ball-screens, drives, isolations, post-ups, off-ball screens, defensive matchups, etc., using an actor-action attention neural network system.

While the one or more techniques for generating tracking data from broadcast video data for non-professional sports (e.g., college basketball) are a breakthrough in the field of sports analytics, additional techniques may also be used to implement the techniques disclosed herein. To showcase the value of the generated tracking data, the present techniques implement a trained prediction model configured to predict the talent of future NBA players based, at least in part, on the generated tracking data. For example, the prediction model(s) described herein are configured to predict the probability of a player's predicted success in a second league (e.g., the NBA) directly from tracking data generated from a first league (e.g., a non-professional league's data). By generating and using the generated tracking data, the present techniques are able to obtain or generate more accurate forecasts of draft-eligible player performance in a second league (e.g., the NBA) compared to traditional or conventional data sources.

Additionally, while projecting or predicting the talent of future NBA players is a substantial contribution to the technical field of sports analytics in and of itself, the present approach may not be limited to a single output. Instead, one or more techniques described herein utilize interpretable machine learning techniques, such as those implemented using Shapley values, to not only create accurate predictions, but also identify the strengths and weaknesses of specific players.

Additionally, the one or more techniques may be configured to generate updated ratings of an individual player's performance in basketball (e.g., the NBA, WNBA, NCAA, etc.) based in part on the generated tracking data. Briefly, since the early years of basketball analytics, many individuals have attempted to condense player statistics into easy-to-digest metrics, including an “all-in-one” rating. Metrics, such as regularized adjusted plus/minus (RAPM), box plus/minus (BPM), and real plus/minus (RPM), have all been used to describe player overall performance and to predict future performance. Such metrics were expanded in number and scope. For example, these metrics may be expanded to include additional metrics such as, but not limited to, luck-adjusted player estimate using a box prior regularized on-off (LEBRON), estimated plus/minus (EPM), robust algorithm using player tracking and on-off ratings (RAPTOR). While all-in-one ratings can oversimplify a player's attributes, they are extremely powerful for team projections, injury adjustment, and generally having a good baseline for overall player value. However, some metrics such as, but not limited to, fouls drawn, times blocked and +/−values for games are not available for some basketball leagues.

Therefore, one or more techniques are provided for applying daily-updated rating of individual performance (DRIP) or similar ratings (e.g., used for NBA player ratings) to players in other leagues such as WNBA, CBK, and WCBK. Full data leagues may include a predefined set of features and statistics over a period of time. For example, a full data league such as the NBA may include one or more statistics per 100 possessions (e.g., points, offensive rebounds, assists, times blocked, on-court offensive/defensive rating, etc.) and one or more 3-year rate statistics (e.g., 2-point field goal percentage, 3-point field goal percentage, free throw percentage, etc.). Partial data leagues may include similar statistics per 100 possession and/or 3-year rate statistics, however, one or more statistics from the full data league may be missing. For example, partial data leagues such the WNBA, CBK, and/or the WCBK may include one or more of the statistics per 100 possessions except for the on-court offensive/defensive rating. Alternatively, the partial data leagues may be missing baseline information (e.g., player “on” time). The DRIP model may be an estimation of the impact a player has on a team. The final output may be a numerical value that shows how many points a player adds to their team per set number (e.g., approximately 100) of possessions. This type of metric is referred to as an “all-in-one” metric. DRIP is a predictive metric that measures a player's true talent level going forward. Additionally, the game-by-game estimations for player box score stats are predicted as well (e.g., points, rebounds, assists, etc.).

In addition to the predictive DRIP metrics, one or more techniques disclosed herein provide reflective DRIP values, which translate to, for example, WAR (Wins Above Replacement) metrics. These metrics may indicate how a player has performed in a given amount of time (e.g., in a season) and has also been adapted for use in partial data leagues (e.g., partial data leagues such as the WNBA, CBK, and WCBK). The WAR metric may define how many wins a player may add over a “replacement” player. For example, in college basketball (CBK and/or WCBK), the value of a “replacement” player is roughly equivalent to your average bench player on an average Division I team. A calculation of WAR may use a similar method to DRIP but combine actual box score and play-by-play data instead of modeling each statistic for future success. Such features are plus/minus, field golds made, assist, etc. Raw numbers may be adjusted on a per set of possessions (e.g., 100 possessions) basis. These numbers may then be used to estimate the impact that a player may have on the court per game. In addition, the numbers may be then aggregated over a time period (e.g., per season). Utilizing multi-layered perceptron (MLP) models and selecting the best model using weighted R-squared scores, the selected MLP models may provide a more accurate approach for this calculation due to MLP models ability to parse data that may not be linearly separable and may produce a better job of preventing overfitting compared to other model (e.g. a tree-based model). The metric may be described as a reflective DRIP metric or a value added performance rating (VAPR). Upon determination of the metric value, VAPR may be adjusted by minutes played to get a more accurate WAR value. A replacement player, as described above, may receive a VAPR of −2.

Accordingly, techniques disclosed herein provide improved all-in-one metrics and predictions for partial data leagues which may also allow improved predictions for fantasy league projections, draft models, transfer portal models, etc. Techniques may include using machine learning to obtain true talent estimates for players in partial data leagues, as well as metrics to inform which players performed the best in a given time frame (e.g., in a season).

Using a variety of filters and models (e.g., multilayer Perceptron (MLP) and Light Gradient-Boosting Machine (GBM)), a player's baseline performance in each game with one or more “rate” statistics (e.g., points, rebounds, assists etc.) may be predicted. For each player, the use of “demographic data” (e.g., height, weight, draft position, age, and playing experience) may be used to generate a baseline level performance for a player's first game. These metrics may then be put into a filter algorithm (e.g., using calculated rates to regress a player's game by game performance) as well as a padded model (e.g., similar to the filter model but regresses the player's performance to the player's career average). The outputs of that model(s) may then be put into an MLP (neural network) and Light GBM (tree-based decision model) to provide an estimation of a rate stat. This process may be done for all of the rate stats calculated. The models (e.g., MLP and Light GBM) may be trained using a sample of NBA player games. For partial data leagues, the models (e.g., MLP and Light GBM) may be trained using stats for each league providing an additional two models. The outputs of the MLP and Light GBM models may be put through a second round of filter algorithms to consistency of output data. Using a combination of these models (e.g., Filter, Padded, MLP (NBA trained), Light GBM (NBA trained), MLP (trained for relevant league), Light GBM (trained for relevant league), Filtered MLP (NBA trained), Filtered Light GBM (NBA trained), Filtered MLP (trained for relevant league), and Filtered Light GBM (trained for relevant league)) the most accurate model may be selected for each rate stat using weighted R-squared scores.

Outputs from the models, as described above, may then be input into an MLP model that serves as the output for the player's DRIP. The “DRIP” model is trained on 3-year regularized adjusted plus minus (RAPM) values (e.g., using lineup data this is a rate stat agnostic estimation of a player's impact on the game for offense and defense). RAPM may include an estimate of how many points per 100 possessions a given player increases his team's scoring, both on offense and defense. The RAPM model may project offensive and defensive RAPM separately and may add each value to provide an overall RAPM. For example, a 3-year period of time box score stats may be used to predict a player's overall RAPM value for those 3 seasons. Using the output of the RAPM model may predict the player's RAPM over the source of those 3 seasons. The box score stats may include, but are not limited to, 2-point field goal attempts and makes, 3-point field goal attempts and makes, free throw attempts and makes, points, offensive rebounds, assists, steals, blocks, turnovers, or the like. The DRIP model may include both an offensive and defensive value that may be added together to provide an overall DRIP value.

In addition to providing the DRIP value, a metric called WAR (Wins Above Replacement) may be generated using the DRIP formula based on a player's actual performance as opposed to their projected performance. To generate a WAR value, an aggregation of a player's box score stats over a specific time are generated (typically a season but may also include a full careers or even individual games). Using a simple formula to convert the players “reflective” DRIP into a WAR value provides an indication of how many wins a player would add over a “replacement” player (your average bench player). This metric may be applied to any basketball league (e.g., full data or partial data) where box score data for players may be available.

An advantage of using the DRIP and WAR models is to utilize projected stats instead of actual stats to determine a player's value. Typical all-in-one metrics currently are “reflective” in that they tell you how much a player has impacted the game so far this season or during their career. This metric may indicate how much a player is expected to impact the game giving a look into what the players “true talent” impact may be. These types of models do not currently exist for partial data leagues (e.g., non-NBA basketball leagues).

While the present techniques described herein are described in conjunction with basketball and projecting athlete performance in, for example, the NBA, such techniques may be applied beyond basketball performance (e.g., to international player performance, to other leagues, or generally to leagues or games that may have less data than another league). Additionally, the present solutions are not intended to be limited to projecting performance in the NBA. Instead, the one or more techniques described herein can be broadly applied to project player performance from a first league to a second league in any sport. As used herein, unless indicated otherwise, a “league” may refer to a live action league such that players in the league are associated with a multi-individual or single individual teams, where the teams compete with other teams in live action settings (e.g., instead of fantasy leagues). For example, the tracking data discussed herein may be generated based on live action sporting events, and thus may correspond to interactions, events, and actions associated with live action events. As discussed herein, such live action event based broadcast and tracking data may be used to make the predictions discussed herein.

Advantageously, a player's future performance in upcoming games (e.g., based on the DRIP value), or in a target (e.g., second) league (e.g., NBA, WNBA, etc.), as measured by a player rating, may be predicted from first league (e.g., college and/or non-college) data captured via broadcast tracking data as described in greater detail below.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

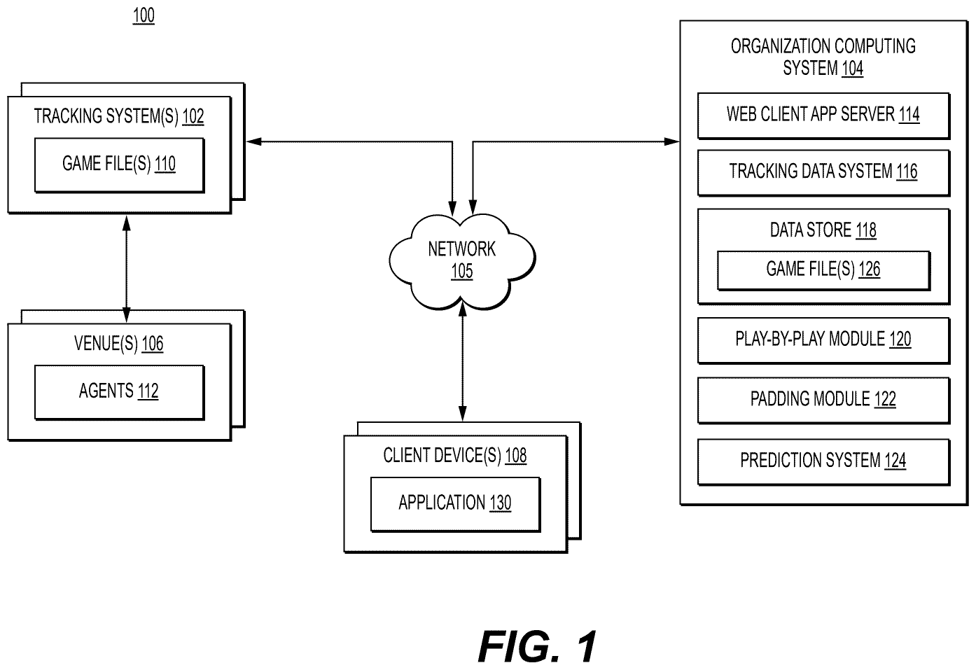

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., sideline, baseline, overhead, player close-ups, coach/bench view, free throw specific views, etc.).

In some embodiments, tracking system 102 may be used for (e.g., to capture or otherwise generate) a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

As an example, tracking data may include the positions (e.g., x=(x, y)) of each entity (or player) at each time step on a playing surface. In some embodiments, to represent the tracking data in a well-defined structure that avoids issues presented in conventional approaches, a pre-processing agent may construct a graphical representation of the tracking data in a digital, computerized, format. For example, a pre-processing agent may construct a graph G (V,E,U) that may be defined by nodes V, edges E, and global features U. In some embodiments, each node in a graph may represent the player and ball tracking data. In some embodiments, each edge may include information about various relationships between nodes. In some embodiments, edges eij may be directed edges and connect a sending node vi to a receiving node vj.

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set

$${U}^{′} = \{ {U}_{1}^{′} , {U}_{2}^{′} , … , {U}_{n}^{′} \} .$$

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

The organization computing system 104 may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] {P₁, P₂, . . . , P_{K}}, where [symbol] may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a foul event, a possession-based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning model(s) to determine correlations between the tracking data and event types (e.g., basket scored, turnover, pass made, play types, etc.). For example, tracking data may be used to determine when a digital representation of an object (e.g., a ball) crosses a scoring object (e.g., through the net of basketball hoop). The determination may be based on, for example, detection of a triggering change between a first tracking data digital representation and a second tracking data digital representation, where the triggering change may be for a given event type. More specifically, the determination may be made based on a component or machine learning algorithm detecting the triggering change between the first tracking data digital representation and the second tracking data digital representation, and automatically identifying correlations between the triggering change and attributes associated with one or more event types. If a correlation meets a correlation threshold for a given event type, the triggering change may be associated with the given event type, and may be tagged as event data for that event type. Such automated event data detection may be performed, for example, by a machine learning model using input data (e.g., tracking data and/or game files) that are in a non-human readable format optimized for machine learning operations. Based on such determination, for example, an event type of a point scored may be identified based on the digital tracking data. Further, the digital representation of the player(s) that contacted the object (e.g., ball) prior to the goal scored event may be identified as the player(s) that contributed to or otherwise caused the event (e.g., scoring). In some examples, the location of the player who scored may be analyzed to determine whether the scoring basket should be assigned two points or three points, based on a player's location being either in front of or behind a three-point line on the basketball court. Accordingly, content feeds may be used to generate digital tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or prediction system 124. Each of tracking data system 116, play-by-play module 120, padding module 122, and prediction system 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds. In some embodiments, tracking data system 116 may largely be representative of an artificial intelligence and computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across 650,000 college basketball possessions, totaling about 300 million broadcast frames. In addition to such process, organization computing system 104 may go beyond the generation of tracking data from broadcast video data. Instead, to provide descriptive analytics, as well as a useful feature representation for prediction system 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations, whether a defense is playing zone or man-to-man defense), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features and may be created by using the tracking data and/or event data discussed herein. For example, one of the profound challenges of modeling using potentially only 20-30 games of NCAA data per player may be the high variance of low frequency events seen in the tracking data. A highly talented one and done player may, for example, only attempt 50 isolation shots in a career. Such limited amount of data may not be enough to generate a robust mean value for the player's isolation shooting percentage. Therefore, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and tracking data. In some embodiments, certain player level statistics, such as height, weight, minutes/possessions played, etc. may be excluded.

Accordingly, for each player, tracking data system 116, play-by-play module 120, and padding module 122 may work in conjunction to generate a raw data set and a padded data set for each player.

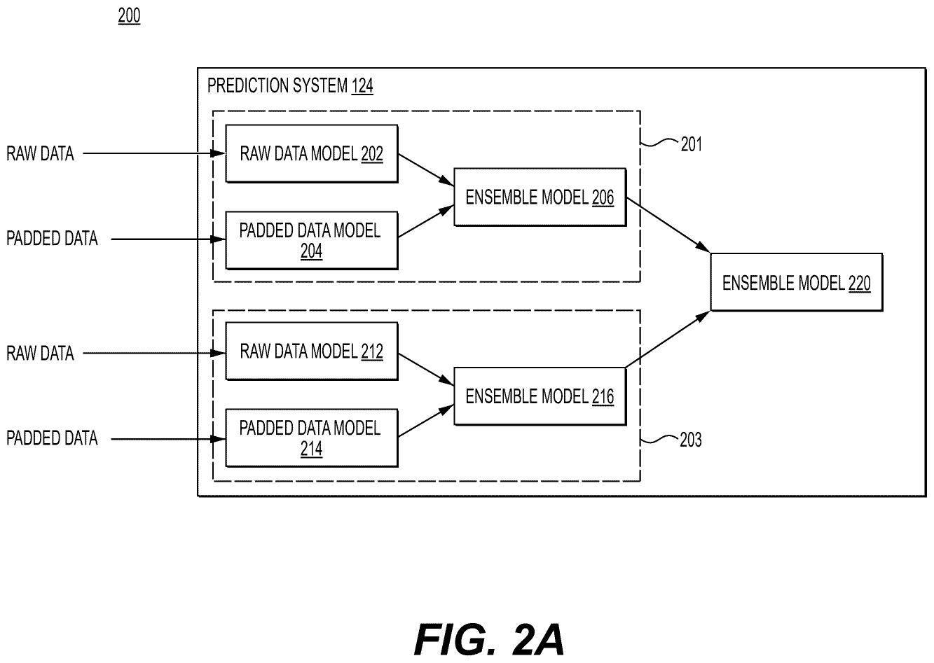

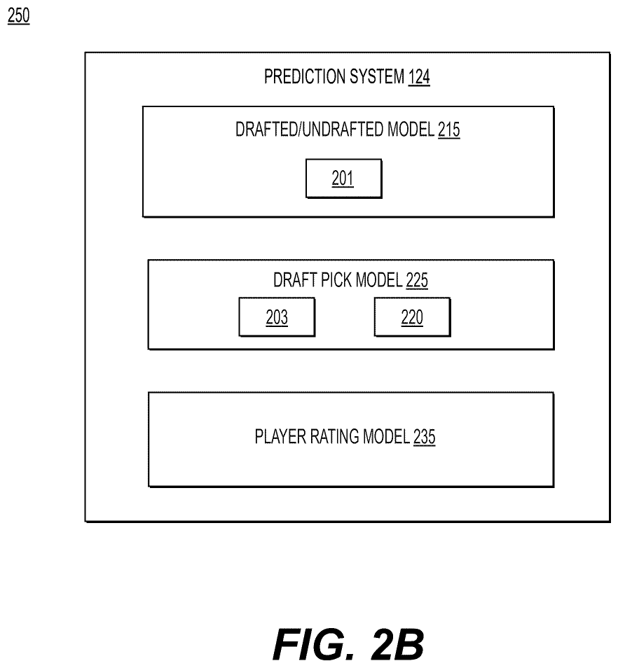

Prediction system 124 may be configured or trained to generate or identify the likelihood of a draft-eligible player to be drafted. The prediction system 124 may further be configured or trained to generate/project a player performance for a league that the player does not currently play in. Prediction system 124 is discussed further in conjunction with FIG. 2A and FIG. 2B provided below. As will be described in greater detail in FIGS. 2A and 2B, the prediction system 124 may include one or more machine learning models.

Prediction system 124 may further be configured or trained to generate or identify next-game predictions for each player. For example, prediction system 124 may be configured to receive data as disclosed herein (e.g., tracking data, event data, rookie priors, time series data points, player position data, box score data, play-by-play data, and the like) as inputs and run the inputs through gradient-boosted decision trees to generate next-game projections for each player. Using the next-game predictions, prediction system 124 may take each statistical output and project a player's contribution to a team's plus/minus per 100 possessions on both offense and defense. In some embodiments, adjusted plus/minus may be used as the target. The final output may be representative of a player's DRIP value. In some embodiments, prediction system 124 may generate three output values: a DRIP value for offense, a DRIP value for defense, and a total DRIP value.

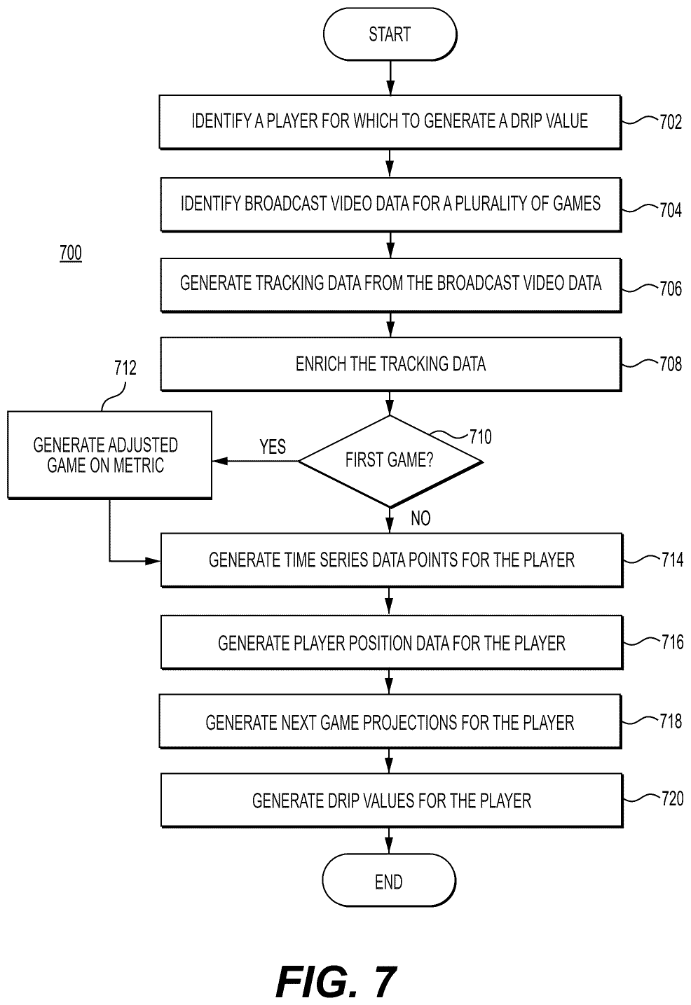

In some embodiments, prediction system 124 may include a separate prediction model tuned for each player. Given that all players are very different from each other, there are times that a prediction model may have trouble projecting their abilities. In such scenarios, projections from prediction system 124 may be compared with real-world or actual statistics. For example, with respect to Steph Curry (a prolific three-point shooter), if prediction system 124 generates a three-point percentage for Curry that is below Curry's average three-point percentage, an operator may adjust the weights of Curry's individualized prediction model. Prediction system 124 is discussed further in conjunction with figures discussed below (e.g., FIGS. 7-9).

An example of a prediction system 124 is now set forth. The prediction system 124 may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions

$${U}_{n} = {[ {x}_{s , n} ]}_{s = 1}^{S}$$

for an agent n∈[1, N] and a frame s∈[1, S]. In some embodiments, M may represent the optimal permutation matrix that enables such an ordering. The goal of the prediction system 124 may be to find the most probable set of [symbol] of two-dimensional (2D) probability density functions:

$${*}^{} = arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${*}^{} = arg {max}_{ℱ} {\sum }_{n = 1}^{N} H ( x \vert n )$$

The prediction system 124 may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a basketball-based sports machine learning model may be trained to correlate or otherwise associate player position information in reference to a basketball court. The basketball-based sports machine learning model may further be trained to correlate or otherwise associate sports data in reference to a number of players and sports targets specific to basketball.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to view NBA content (e.g., games, news, draft projections of draft eligible players, etc.). The content that is displayed to client device 108 may be transmitted from web client application server 114 to client device 108 and subsequently processed by application 130 for display through a graphical user interface (GUI) of client device 108.

While men's basketball used to rarely enlist talent from countries other than the USA, men's basketball has shifted to become a true international sport. The most recent International Basketball Federation (“FIBA”) world cup highlighted this with team USA placing fourth overall behind Canada, Germany, and Serbia. Additionally, since 2000, at least ten players from outside of the United States were drafted each year, and at least two were picked in the top ten over the last eleven drafts. Moreover, for example, the last five most valuable players (“MVPs”) in the NBA were all born outside of the United States. With this influx of talent coming from various leagues and countries, there may be a desire to gather and use non-college data to pick the best players in the draft, as well as predict said players' future performances and analyze said player' past performances. However, teams play quite differently style-wise across leagues compared to the NBA/college basketball, with subtle rule changes enabling international leagues to be more physical and enabling players to be more team oriented. For example, the United States finished last in passes per game in the FIBA World cup.

Player and/or ball tracking data may be very useful for analyzing players. A new type of tracking data that uses broadcast video and computer vision to get the tracking data is disclosed herein. This may make it possible to collect player tracking data for non-NBA games, as well as incorporating player tracking data from NCAA games and international leagues that otherwise may be difficult to interpret with only box scores. It will be understood that although examples provided herein discuss NBA, WNBA, NCAA, and/or international leagues, techniques disclosed herein may generally apply across any two or more leagues, groups, cohorts, and/or locales.

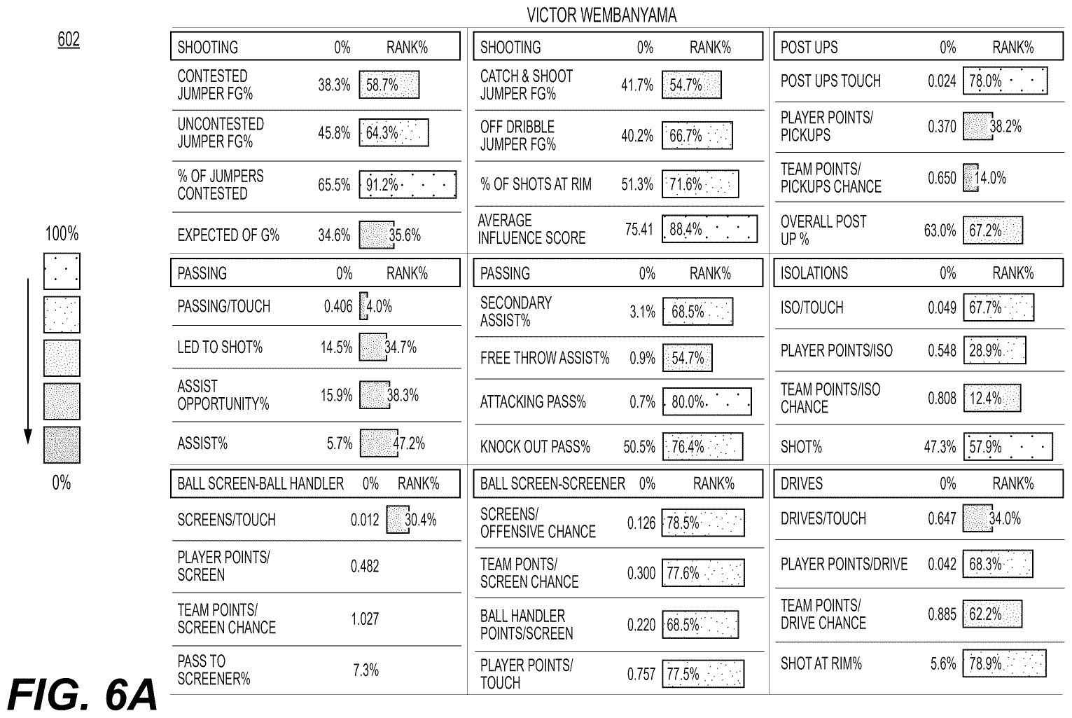

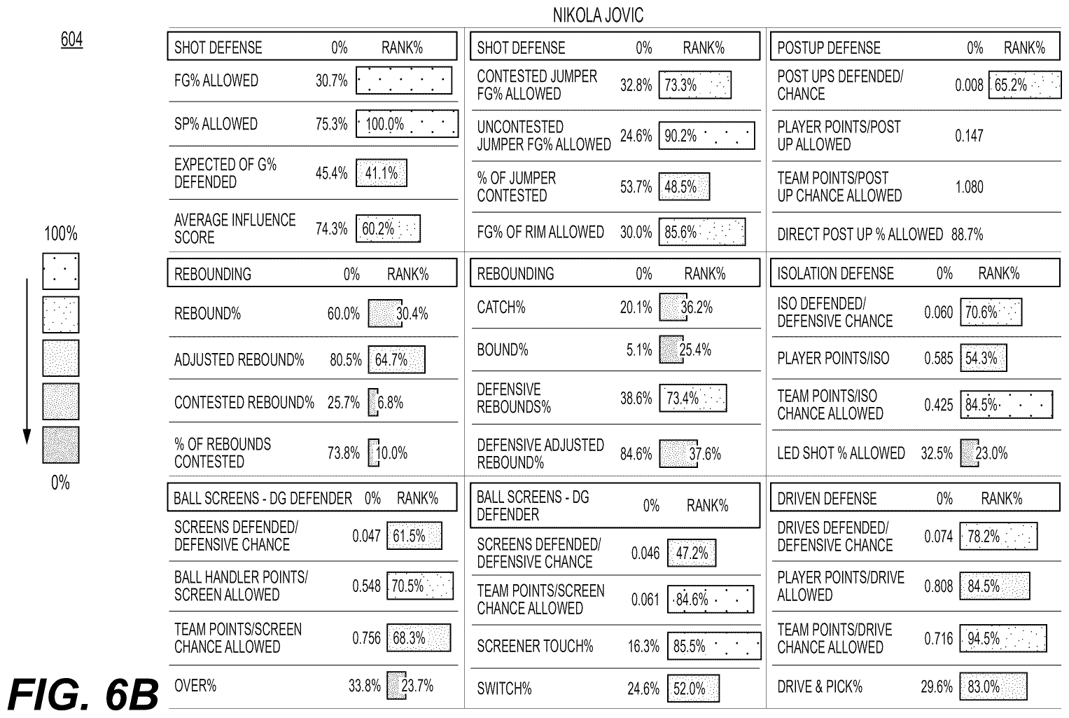

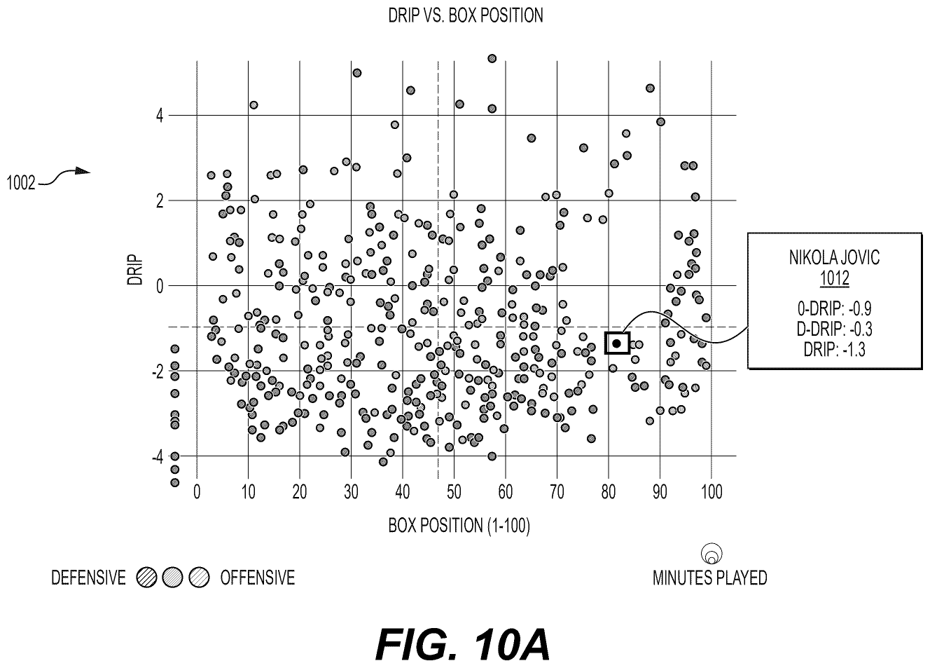

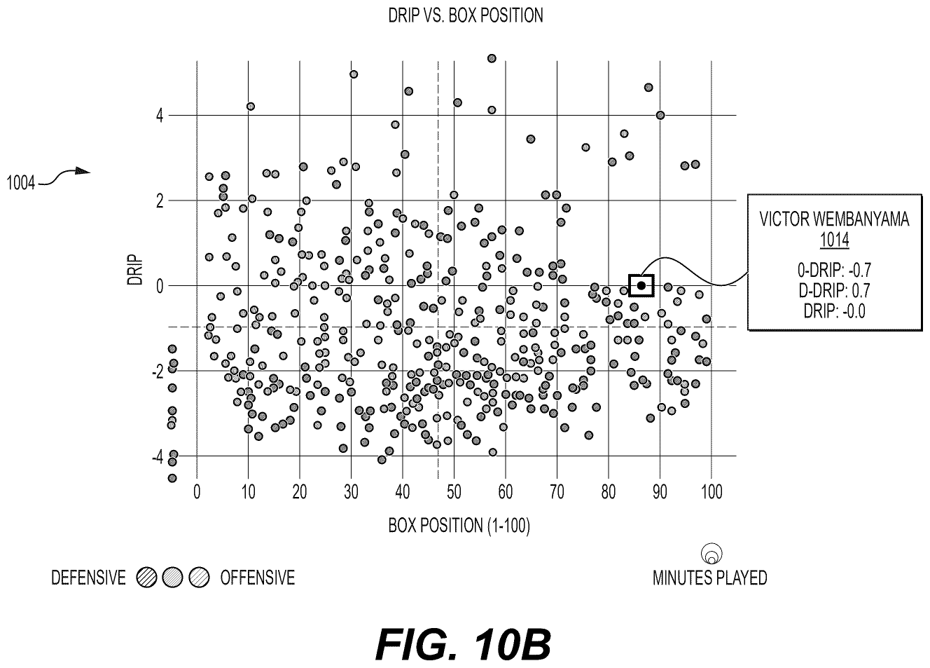

Given that the NBA may still be viewed as the top competition in the world, the lure of top international players to come to the NBA may be very strong. For NBA teams, deciding who to draft and how to value players may be difficult, as detailed data at scale may not have been available for international players. However, users may now find hidden talent outside of the United States by utilizing broadcast tracking, box score data, and biometric data. FIG. 6, as will be described in greater detail below, illustrates exemplary statistics from player tracking data collected from international events for two international players (e.g., Victor Wembanyama and Nikola Jovic), according to one or more embodiments. FIGS. 10A and 10B, which will be described in greater detail below, illustrates exemplary Dailly Updated Rating of Individual Performance (“DRIP”) values for Victor Wembanyama and Nikola Jovic, according to one or more embodiments. This is an exemplary player rating that may be generated by implementing the techniques described herein. The process of generating DRIP values for players is referenced specifically with regards to FIGS. 7 to 9.

Such data further may be normalized/utilized to allow for the comparison with the plethora of data already collected from competitions within the USA (e.g., NBA, WNBA, NCAA). For example, the international data may be utilized to predict the player's future NBA player ratings. Generally, data related to players from one league or group may be utilized to predict future player ratings in another league or group.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth. For example, techniques disclosed herein may be applied to different leagues within a given sport.

FIG. 2A is a block diagram 200 illustrating aspects of the prediction system 124 of FIG. 1, according to example embodiments. As shown, prediction system 124 may include one or more models. For example, prediction system 124 may include a first set of models 201 and a second set of models 203. First set of models 201 may be configured to, for example, generate a prediction related to likelihoods of a player entering the NBA. Second set of models 203 may be configured to generate a prediction related to the player's projected draft pick. An ensemble model 220 may be used to classify the player into one of several bins, with each bin representing a range of draft picks.

As shown, first set of models 201 may include a raw data model 202, a padded data model 204, and an ensemble model 206. Each of raw data model 202, padded data model 204, and ensemble model 206 may be referred to as classification models. For example, instead of using only the padded data, prediction system 124 may include two models—raw data model 202 using the raw data and padded data model 204 using padded data—and then ensembling the results using ensemble model 206. In some embodiments, for each of the raw data set and the padded data set, each data set may be prepared similarly for processing. For example, with the high dimensionality and relative similarity between many of the features, pairs of features that may be high collinear may be halved, starting with the most highly correlated. Whichever of each pair was more correlated with remaining features may be removed until no two features had an R2 above a certain threshold (e.g., =>0.95).

In some embodiments raw data model 202 for the raw data may be representative of a LightGBM classifier. In some embodiments, padded data model 204 for the padded data may be representative of a LightGBM classifier. In some embodiments, the hyperparameters for each of raw data model 202 and padded data model 204 may be tuned using five-fold cross validation on a random search across a parameter grid. By using a classifier, each model's predictions may be representative of a probability of the player entering the NBA.

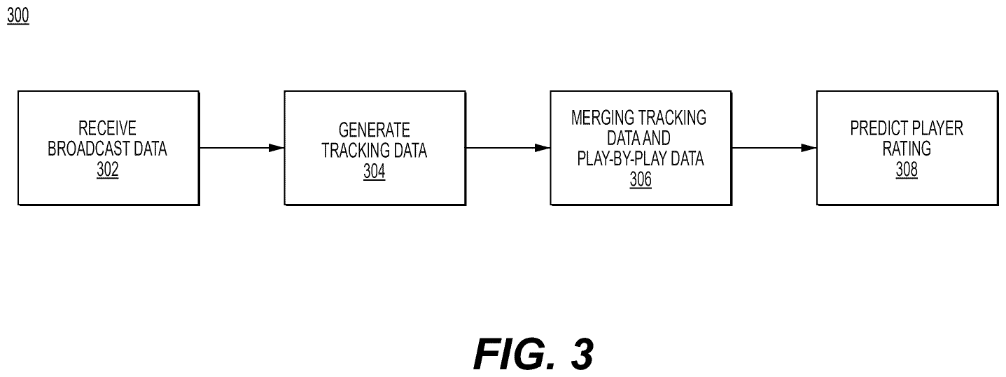

In some embodiments, the ensembling of both outputs from raw data model 202 and padded data model 204 may work to include predictive information contained separately in both data sets. The feature space for the ensemble, such as via a random forest classifier, may be the raw prediction, the padded prediction, and/or chances per game, and may be a tracking data or event data derived feature that may be analogous to possessions per game. For example, in some embodiments, raw data model 202 and padded data model 204 may be configured to receive tracking data (generated, e.g., by tracking system 116) and/or event data. In conjunction with the ensemble model 206, the raw data model 202 and padded data model 204 may use the tracking data and/or event data to predict tracking data and/or event data for subsequent games. Further discussion of this process is provided below with respect to FIG. 3.

In some embodiments, in order to properly understand why raw data model 202 and padded data model 204 made their predictions, prediction system 124 may utilize Shapley values, which is a game theory approach to interpret results of machine learning models. The Shapley values may provide, on a per-prediction basis, the direction and magnitude of each feature's contribution to the overall prediction. By combining the Shapley values for each of raw data model 202 and padded data model 204, the result may be used to understand the interplay between the raw data and the padded data, and the differing information they may provide.

While the outputs generated by each of raw data model 202 and padded data model 204 may be useful for understanding how the models function, the outputs may be used to trim the overall dataset of players to those plausible NBA players and begin the actual draft modeling. For example, raw data model 202 and padded data model 204 may be used to identify those players with greater than an x % (e.g., 40%) chance to make the NBA.

Second set of models 203 may be used in conjunction with first set of models 201 for projecting a range of draft picks in which a player may fall. As shown, the overall architecture of prediction system 124 may include first set of models 201 (described above), raw data model 212, padded data model 214, and ensemble model 216. Raw data model 212, padded data model 214, and ensemble model 216 may share all, some, or none of the capabilities of raw data model 202, padded data model 204, and ensemble model 206, as discussed above. As shown, the new components for the talent bin ensemble model may reuse the framework, where both the decorrelated raw and decorrelated padded data may be used in separate models and then ensembled to create three sets of predictions that may be carried forward. In some embodiments, each of raw data model 212 and padded data model 214 may be random forest regressors using a value over replacement player (“VORP”) pick value at each draft pick target. The predictions from raw data model 212 and padded data model 214 may then ensembled, with additional information from the make NBA models using NGBoost (e.g., ensemble model 216) to create regression predictions with independently modeled means and variances. The outputs from all existing and new components may be ensembled using a random forest multiclass classifier (e.g., ensemble model 220). For example, output from ensemble model 220 may classify a player into one of several bins. Exemplary bins may include:

TABLE 1
Bins and Associated Pick Ranges.

| Bin | Pick Ranges |
|---|---|
| 1 | 1-2 |
| 2 | 3-5 |
| 3 | 6-8 |
| 4 | 9-12 |
| 5 | 13-17 |
| 6 | 18-26 |
| 7 | 27-39 |
| 8 | 40-50 |
| 9 | 41-61 |

FIG. 2B is a block diagram 250 of a set of models within the prediction system 124 of FIG. 1, according to example embodiments. FIG. 2B may display the drafted/undrafted model 215, the draft pick model 225, and the player rating model 235. These may be models within the prediction system 124 utilized to predict player ratings for one or more players.

The drafted/undrafted model 215 may include the first set of models 201 described in FIG. 2A. The drafted/undrafted model 215 may be configured to receive/determine tracking data from one or more players. In some examples the tracking data may include coordinates of player positions and ball positions for frames of a broadcast. In some examples, the tracking data may have been generated based on broadcast data, as discussed herein. The drafted/undrafted model 215 may further be configured to receive play-by-play data for a plurality of games for a player. The play-by-play data may describe events that occurred within the games (e.g., corresponding to the event data described herein). The drafted/undrafted model 215 may further be configured to receive biographical data for a player, the biographical data including includes age, height, and weight of the first player. In some examples, the prediction system 124 may merge the play-by-play data for each of the plurality of games with tracking data of the plurality of games to generate a set of input features. This may include combining play-by-play data with optical character recognition data, the coordinates of player positions and ball positions being combined using a fuzzy matching algorithm.

The tracking data may be differentiated to be associated with a league player. For example, the tracking data may include multiple lines for players, where the lines may represent the different seasons that a player played in. In order to get a unified column for each player, the rows of data may be aggregated based on the number of games played in the season. The result may include a weighted summation of each column for each player.

As explained above, non-college leagues may be very different from college leagues. Data from earlier seasons in a player's college career may be more predictive than data from later in a player's career, therefore freshman/sophomore year statistics may be weighted more heavily. In some examples, the multiplier may be applied to box score information associated with player's statistics. This may result in an incorporated multiplier based on year and league as shown in table 2 below.

TABLE 2

| | Most | | | |
|---|---|---|---|---|
| | Recent | | Any season Earlier | |
| | Season | Previous | (Freshman/ | International/ |
| | (S) | Season (S − 1) | Sophomore season) | G-League |
| Multiplier | 2 | 3 | 5 | 1 |

The drafted/undrafted model 215 may incorporate a Random Forest classification algorithm that may be utilized to classify an observation (e.g., drafted/undrafted) along with the synthetic samples that may have been created with oversampling. The Random Forest classification algorithm may be utilized as it does not over fit as much as a decision tree, and it allows for easy access of feature importance. The result may be viewed in two different ways: probability of being in each class and/or the predicted class. The probabilities may provide a better understanding of the closeness of the classes, and/or if the model is doing a good job at providing the predictions.

The draft pick model 225 may include the second set of models 203 and the ensemble model 220. The draft pick model 225 may predict a player's draft bin. The draft pick model 225 may receive input data that may include some or all of the data received by the drafted/undrafted model 215, as well as the probability of a player not being drafted (e.g., from the output of the drafted/undrafted model 215). Additionally, the draft pick model 225 may receive DRIP values for one or more players. Discussed in greater detail below, DRIP values may be calculated for non-NBA players (e.g., CBK players, international players, WNBA players, etc.). These DRIP values may be input into the draft pick model 225 to improve the accuracy of predicting draft spots for a group of draftees. For example, a CBK player's DRIP values (offensive DRIP, defensive DRIP, total DRIP, etc.) during their final season of play may be input into the draft pick model 225. The draft pick model 225 may be a Random Forest model. Based on said DRIP values, draft pick model 225 may be used to measure predicted DRIP values for the CBK player's first four years in a professional league (e.g., the end of a typical rookie contract in the NBA, WNBA, etc.). In some examples, the CBK offensive DRIP values may be important in predicting professional (e.g., NBA, WNBA, etc.) offensive

DRIP values (e.g., represented by an importance value of 0.36), and the CBK defensive DRIP values may accurately predict professional (e.g., NBA, WNBA, etc.) defensive DRIP values (e.g., represented by an importance value of 0.2). This feature (e.g., whether a player is drafted or not) may be weighted to account for the imbalance in classes of players when generating a prediction. Predicting and incorporating whether a player is drafted first may lead to more accurate results from the draft pick model 225. In some examples, synthetic oversampling may be utilized to raise the group of draftees to the same amount as the group of undrafted players. The output of the drafted/undrafted model may be fed into both the draft pick model 225 and the player rating model 235.

The draft pick model 225 may incorporate an algorithm to perform classification. In particular, the draft pick model 225 may classify player into bins. The bins may represent ranges of draft picks that a player may be modeled in. The bins may have been determined through a smoothed VORP and/or created dynamically. FIG. 10, described below, illustrates an exemplary distribution of observations for each class and each set of bins, according to one or more embodiments.

The draft pick model 225 may incorporate algorithms including one or more of: logistic regression, Random Forest, Artificial Neural Networks (ANN), Relu and Softmax activation functions of the ANN, an Adam optimizer, and/or a categorical cross entropy loss. In some cases, the draft pick model may have been trained and tested on real life data. The training and testing data may be split based on start year with the training data including one or more players who, for example, started 2012-2021, and the testing data including one or more players who, for example, started in 2022 and 2023. Before implementing the algorithm, one or more feature reduction methods may be utilized. For example, one or more features may be eliminated, where such features may have been automatically or manually selected as not being influential to the predictability of the model. A Principal Component Analysis (“PCA”) may be utilized, where the PCA may reduce the features (columns) by combining them into a specific number of components. Additionally, or alternatively, Recursive Feature Elimination (“RFE”) may be utilized, where RFE may recursively look through all the features and eliminate one or more of the features that may be less important, which may reduce overfitting and improve model accuracy. The output of the draft pick model 225 may be input into the player rating model 235.

The player rating model 235 may be configured to receive inputs from the drafted/undrafted model 215 and the draft pick model 225. The player rating model 235 may include these inputs as normalized features to consider. Further, the player rating model 235 may be configured to receive the same input data received by the drafted/undrafted model 201 and/or the ensemble model 220. The player rating model 235 may incorporate a Random Forest algorithm that may be utilized to analyze each season of data. The predicted player ranking may be based on the predicted DRIP and the actual rank may be based on ap layer's true DRIP determined by the player rating model 235.

FIG. 3 is a flowchart 300 for predicting a player rating, according to example embodiments. The method of FIG. 3 may be implemented by environment 100 of FIG. 1 and the prediction system 124 of FIG. 2A and FIG. 2B.

Step 302 may include receiving broadcast data for a plurality of games in a first league, the plurality of games including a first player. The broadcast data may include video formats of sporting events that include sets of frames. For example, the plurality of games may correspond to all games or a subset of games for a particular team in a league. In some examples, the plurality of games may include multiple seasons worth of broadcast data. In some examples, step 302 may include receiving a plurality of games for a second league (e.g., in scenarios where the first player has played in multiple different leagues).

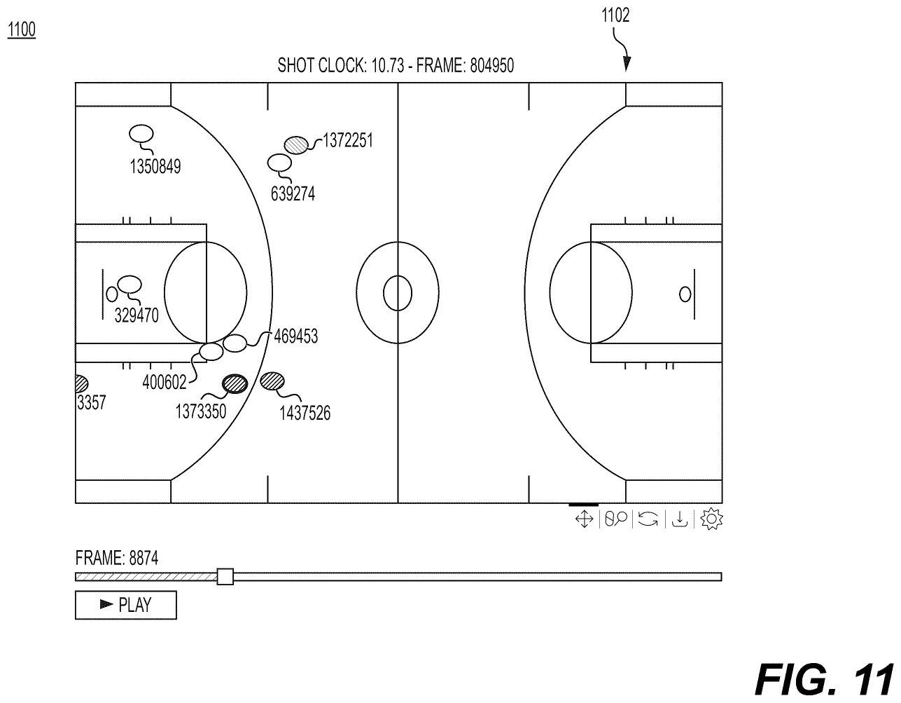

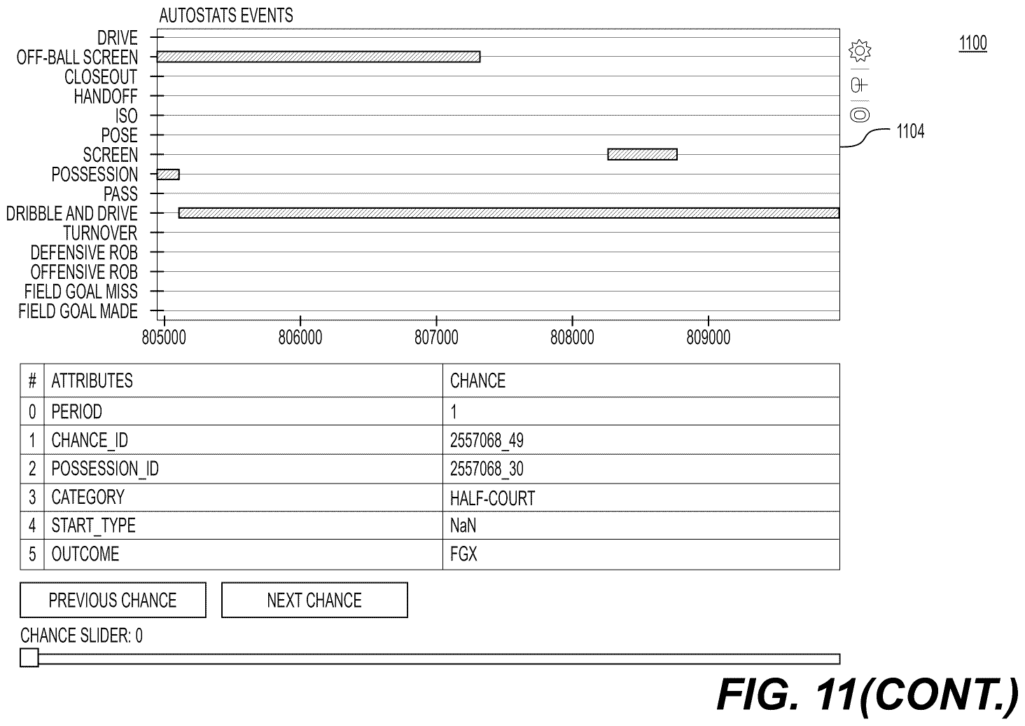

Step 304 may include generating tracking data for each of the pluralities of games, the tracking data including digital coordinates of player positions and ball positions for each frame for the broadcast data, as discussed herein. This may include incorporating the techniques implemented by the tracking system(s) 102 described in FIG. 1 and discussed in reference to FIG. 2A and FIG. 2B. For example, the tracking data may be generated based on analyzing the fames of the broadcast data. The tracking data may capture the player and ball positions (e.g., x, y coordinates) at one or more frames (e.g., 30 frames per second). Step 304 may also include utilizing a machine-learning based system to automatically detect event data such as advanced markings from the raw positioning data as well as the play-by-play information, where the advanced markings may capture one or more of: passes, touches, drives, isolations, post-ups, on-ball screens (with defensive coverages), off-ball screens (with defensive coverages), hand-offs, close-outs as well as defensive match-ups at the frame-level. FIG. 11 described below may illustrate an exemplary snapshot of the player tracking and markings detected from the broadcast tracking system, according to one or more embodiments.

The method may further include receiving play-by-play data (event data) for each of the plurality of games, the play-by-play data describing events that occur within the plurality of games. The play-by-play data may include time stamps of when an event occurs, and an action and corresponding players involved in action. For example, a play-by-play data may include a pass from player A to player B with 4:24 remaining in the third quarter. The play-by-play data may be overlayed with the tracking data. In some examples, the method may further include receiving biographical data for a first player, the biographical data including age, height, and weight of the first player. The method may include incorporating a hierarchical approach to normalize/utilize data from different leagues (e.g., from a first league and from a second league). For example, data for steps 302 and 304 may be received from multiple international leagues and or amateur leagues such as college basketball. The process of FIG. 3 may be applied to analyze the first player's predicted performance in a second league (e.g., NBA, WNBA).

The method may further include receiving box score data for the plurality of games in the first league. The box score information for each game may correspond to a game by identifying a time, data, and team associated. The box score for each game may further include, for each player in the respective game, the player's minutes, points, rebounds, assists, steals, blocks, turnovers, field goals made, field goals attempted, three points attempts, three points made, free throws attempted, and free throws made. The method may include converting box score data for college and other leagues into a similar scale because the box scores for college may be very different from those of international leagues. This may normalize all recorded stats of the box score.

In some examples, the method may include applying a multiplier to the box score data based on the first league, wherein the multiplier is based on the first league and particular year of the first player playing in the first league. For example, earlier college seasons may be more important for predicting how a player will do in the NBA than later seasons, the multipliers may thus place emphasis on box scores for players in a first year of a first league as compared to a third or fourth year in the figure league.

Step 306 may include merging the tracking data and play-by-play data to generate a set of input features. This may further include merging the box score data with the tracking data and play-by-play data to generate the set of input features. This may include combining the play-by-play data with optical character recognition data, the coordinates of player positions and ball positions using a fuzzy matching algorithm. In some examples, this may include incorporating the biographical data for the first player into the set of input features. In some examples, the set of input features may be approximately 200 features. In some examples, the method may include reducing random noise in the set of input features by creating new player representations using mean-regression.

The set of input features generated by merging tracking data and play-by-play data may be one sequenced data set. As previously noted, the set of input features may be predicted tracking data and/or event data for subsequent games (e.g., generated with the ensemble model 206, the raw data model 202 and padded data model 204, where the ensemble model 206 performs the merge operation). The set of input features may be generated via a merger (e.g., ensemble model 206, etc.), which may utilize a fuzzy matching algorithm, which may combine play-by-play data, optical character recognition data (e.g., shot clock, score, time remaining, etc.), event data, and play/ball positions (e.g., raw tracking data) to generate the set of input features. For example, the merger may receive event data and/or play-by-play data of a shot by Player A, including the time of the shot. The merger may further receive tracking data of Player A, which may include tracking data of the shot and data regarding the time of the shot. Based on, for example, the time of shot of the event data/play-by-play data and the data regarding the time of the shot of the tracking data, the merger may determine that that Player A made a shot at a specific location, the location of other players on the court, and the kinematics (e.g., player movement) related to the shot.

Given the unreliable nature of play-by-play data in terms of timing (however, the ordering of events is reliable), the merger may first perform coarse matching operations by associating chunks of possessions from the play-by-play data to the tracking data. Within that possession chunk, merger may then match play-by-play data to the tracking data. For example, merger may analyze the tracking data and event data or play-by-play data to align the data sequentially. Once aligned, the set of input features may be further refined. For example, tracking data system 116 may use the play-by-play data to refine the player and ball positions and precise frame of the end of possession events (e.g., shot/rebound location). In some embodiments, tracking data system 116 may further be configured to enhance the set of input features with contextual information.

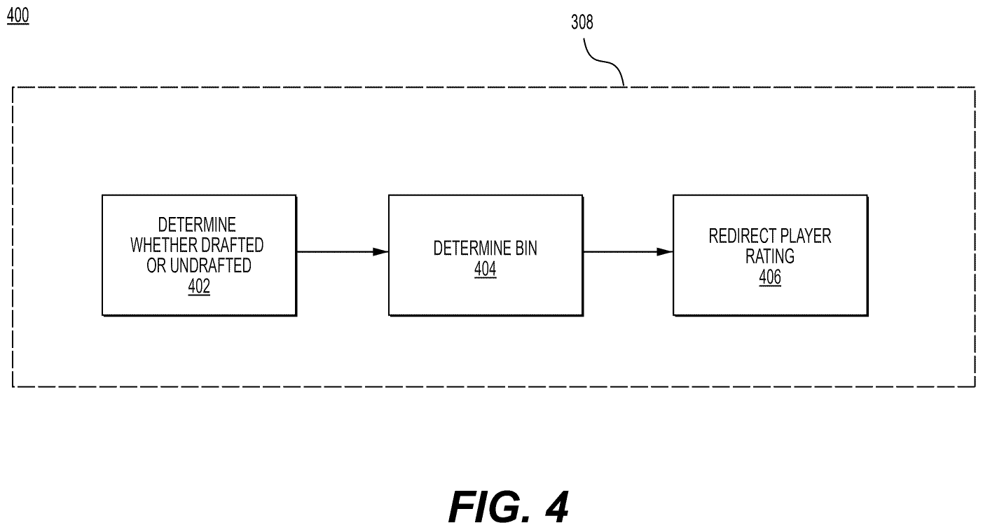

Step 308 may include predicting, based on the set of input features, a player rating for the first player, the playing rating being indicative of a predicted level of performance in a second league. Predicting the player rating in a second league (e.g., NBA) may be performed, for example, in three parts as shown in FIG. 4. FIG. 4 is a flowchart for implementing one or more models to predict a player rating, according to example embodiments. The method 400 of FIG. 4 may be implemented by environment 100 of FIG. 1 and the prediction system 124 of FIG. 2A and FIG. 2B.

Step 402 may include predicting, by applying a first decision tree model algorithm such as a random forest classification algorithm (e.g., of the drafted/undrafted model 215 of FIG. 2B), a classification for the first player, the classification being a prediction of whether the first player will be drafted in the second league. The classification for the first player may be further incorporated into the set of input features for further analysis. The classification may be made based on an output of one or more steps of FIGS. 2A, 2B, and/or 3.

Step 404 may include predicting, by applying an artificial neural network (e.g., of the draft pick model 225), a bin from a plurality of bins, wherein the plurality of bins represents sets of draft picks in the second league. Applying the artificial neural network may include applying a Relu and softmax activation function, applying an Adam optimizer, and applying categorical cross entropy loss to the set of input features to predict the bin of the first player. The set of input features may include any of the input features discussed above and more, including tracking data, event data, play-by-play data (and the merged data, as discussed above), box score data, DRIP values (e.g., CBK DRIP values, etc.), biographical data, player rankings, and so forth. In some examples, the bins may be the bins and corresponding draft picks of Table 1 described above. In some examples, the bins may have been determined through a smoothed VORP and/or created dynamically. The predicted bin may further be incorporated into the set of input features.

Step 406 may include predicting the player rating based on the input features, by, for example, applying a first random forest algorithm to the input features to predict the player rating. In some examples, predicting the player rating may include predicting a collection of player ratings for the first player, each of the collection of player ratings being for a separate year of the first player in the second league. Step 406 may further include applying a second random forest algorithm (e.g., of the player rating model 235) to the input features to enhance the player rating/smooth the data produced by the first random forest algorithm.

In some examples, the outputs of step 404 may be used as features to predict a player's rating at step 406. The probabilities given for a player for each draft bin from the previous model may be multiplied by the average WAR value then added to get a weighted sum as a feature. For example, the equation may be as follows:

$$P {W}_{f e a t u r e} = {P}_{1 - 4} * Av g ( {W}_{1} , {W}_{2} , {W}_{3} , {W}_{4} ) + {P}_{S - 8} * A v g ( {W}_{S} , {W}_{6} , {W}_{7} , {W}_{8} ) + … + {P}_{31} * Av g ( {W}_{31} , {W}_{32} , … {W}_{S 9} , {W}_{60} )$$

The rest of the input data may include the same inputs used in the previous models. For example, the future ratings may be DRIP values and WAR values for each individual player for up to 6 seasons in the NBA. The DRIP values and WAR values may be aggregated to be one row per year for each player. It may then be rotated where each column was a year, and the rows are the players as seen below in Table 3 below. Table 3 may be an exemplary output of the player rating model 235.

TABLE 3
Part 1

| playerid | player | season | DRIP_Off_Prediction | DRIP_Def_Prediction |
|---|---|---|---|---|
| 707832.0 | Fred | 2022.0 | 1.907385 | −0.334632 |
| | VanVleet | | | |
| 707832.0 | Fred | 2022.0 | 1.850591 | −0.312507 |
| | VanVleet | | | |
| 707832.0 | Fred | 2022.0 | 1.543015 | −0.192051 |
| | VanVleet | | | |
| 707832.0 | Fred | 2022.0 | 1.834233 | −0.088352 |
| | VanVleet | | | |
| 707832.0 | Fred | 2022.0 | 1.932048 | −0.218965 |
| | VanVleet | | | |
| 707832.0 | Fred | 2022.0 | 1.769957 | −0.101187 |
| | VanVleet | | | |
| 712593.0 | Gary | 2022.0 | −0.527990 | −0.258852 |
| | Harris | | | |
| 712593.0 | Gary | 2022.0 | −0.553192 | −0.168103 |
| | Harris | | | |
| 712593.0 | Gary | 2022.0 | −0.466560 | −0.102442 |
| | Harris | | | |
| 712593.0 | Gary | 2022.0 | −0.513525 | −0.001982 |
| | Harris | | | |
| 712593.0 | Gary | 2022.0 | −0.448420 | −0.004637 |
| | Harris | | | |

TABLE 3
Part 2

| player id | year 1 | DRIP_OFF_YEAR1 | DRIP_DEF_YEAR1 | year 2 | DRIP_OFF_YEAR2 | DRIP_DEF_YEAR2 |
|---|---|---|---|---|---|---|
| 173004.0 | 2012.0 | 0.641392 | 1.194074 | 2013.0 | 1.044821 | 1.789051 |
| 214152.0 | 2012.0 | 3.387108 | 1.078836 | 2013.0 | 4.369724 | 0.757085 |
| 226806.0 | 2012.0 | −1.067177 | 0.433148 | 2013.0 | −1.380169 | 0.052798 |
| 229598.0 | 2012.0 | 2.526475 | 0.642962 | 2013.0 | 2.612661 | 1.119430 |
| 229602.0 | 2012.0 | −0.474460 | 0.289930 | 2013.0 | 0.109330 | 0.593221 |
| 263903.0 | 2012.0 | −0.529395 | 0.487199 | 2013.0 | −0.963924 | 0.600471 |
| 266358.0 | 2012.0 | 0.070436 | 0.597968 | 2013.0 | 0.358763 | 0.242598 |
| 266367.0 | 2012.0 | −1.168994 | −0.039034 | 2013.0 | −0.172718 | 0.017013 |
| 266394.0 | 2012.0 | 0.964491 | 0.955729 | 2013.0 | 1.793901 | 0.881856 |
| 277552.0 | 2012.0 | 0.612024 | 0.576847 | 2013.0 | 0.799219 | 0.863695 |
| 280587.0 | 2012.0 | −0.111815 | 1.006907 | 2013.0 | 0.028277 | 1.179532 |
| 295809.0 | 2012.0 | 0.543239 | 0.126537 | 2013.0 | 1.316747 | 0.128908 |

Table 3 Part 1 shows different rows with different player rating predictions for each player's first seasons, second seasons, third seasons, etc. Table 3 Part 2 shows a subset of the columns of Table 3 Part 1 combined into one row.

Additionally, for example, missing values may be filled in by default values if a player did not play in their first year. A default value may be utilized if a player did not play during a particular year that the player was drafted. However, if the player missed a year after already playing a season, the default value may correspond to the previous year's value. The data may then split into a particular number of years (e.g., 6 years) with the corresponding player's input values. Each year's data may then be split randomly into training and testing sets. The training and testing sets may then be used in a model (e.g., of the player rating model 235). This may result in one or more models (e.g., 6 models) trained and tested on multiple sets (e.g., 6 sets) of data. Each model may represent the season number a player played in. For example, model one may represent the first season a player played in the NBA.

To accomplish the above, the process may include randomly splitting the training and testing sets. After the splitting, one or more columns may be dropped. For example, the dropped columns may include columns that were highly correlated. Additionally, a Random Forest algorithm may be utilized for each season. This may result in the algorithm performing a prediction with a low error.

In some examples, the player rating may utilize DRIP values and/or WAR values. In some examples, the player rating may utilize additional metrics such as Regularized Adjusted Plus-Minus (“RAPM”), Daily Adjusted and Regressed Kalman Optimized (“DARKO”), Estimated Plus Minus (“EPM”), and/or Player Impact Plus-Minus (“PIPM”). In some examples, DRIP may be utilized for player rating because it may model a player's true talent estimate for each statistic. For example, DRIP may utilize box score data, play-by-play data, and/or line up data to predict each player's contribution to their team's offensive and defensive ratings for the regular season. A similar approach may be used to model other all-in-one metrics.

WAR may be derived from a player's DRIP rating to estimate how many wins a player may have contributed to the player's team over a replacement level player. DRIP may estimate a player's value at a given moment while WAR may estimate a player's value over the course of the entire season. In some embodiments, for example, the player's performance may be predicted between the first to sixth seasons of the player's NBA career. As result, six versions of input and output data may be created for each model. More details regarding generating DRIP and WAR values are discussed with respect to FIGS. 7 to 9.

The predicted player ratings from FIG. 3 and FIG. 4 may be output and utilized for further analysis. In some examples, the output of player bin predictions may be utilized to grade a previous or on-going draft. For example, this may include applying an algorithm to determine a distance comparing an actual draft position compared to a predicted bin. A grade may be assigned based on a distance between a projected bin and an actual bin, where a shorter distance is associated with a higher graded draft pick. One or more machine learning models may be refined or trained based on the distance and/or distance.

In another example, the method of FIG. 3 may be applied various times to a set of players for an upcoming event (e.g., an upcoming draft). The player ratings may then be categorized and ranked to define a set order for drafting the players. Based on the player ranking, a mock draft list of projected players may be generated. The mock list may be output for display via a graphical user interface and may be ordered based on a ranking (e.g., per category) based on the highest ranked to the lowest ranked player in the draft list.

In another example, the method may include determining whether a player can be drafted in a certain round based on a player rating being greater than a threshold value. This may be utilized as a check to confirm that a player rating is of a certain level prior to conducting a draft pick.

In some examples, the player ratings may be uploaded to one or more separate systems. The separate systems may generate simulations of how players may play in various simulated scenarios. The player ratings may be implemented to generate more accurate simulations. Such simulations may be implemented based on the player ratings and/or historical tracking data and/or event data associated with a given player or set of players. The simulations may further be based on predicted simulated play based on outputs of the prediction system 124.

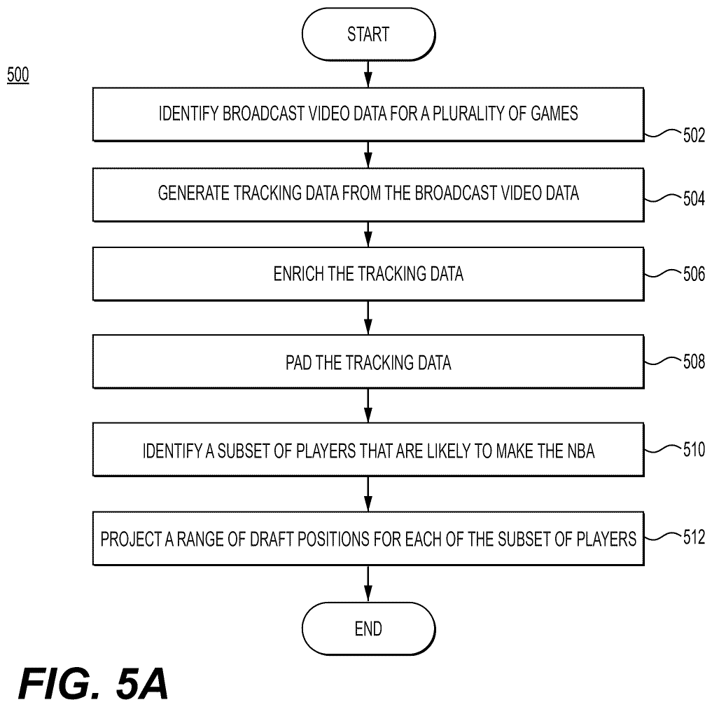

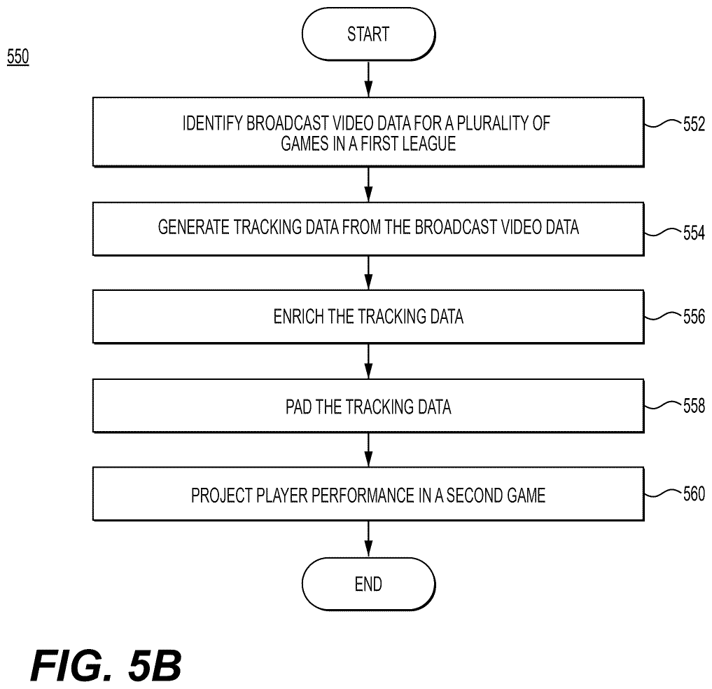

FIG. 5A is a flow diagram illustrating a method 500 of predicting a range of draft positions for a draft eligible player, according to example embodiments. Method 500 may begin at step 502.

At step 502, organization computing system 104 may identify broadcast video data for a plurality of games. In some embodiments, the broadcast video data may be received from tracking system 102. In some embodiments, the broadcast video data for a game may be stored in data store 118. For example, the broadcast video data may be stored in a game file 126 corresponding to a game or event. Generally, the broadcast video data may include a plurality of video frames. In some embodiments, one or more video frames of the broadcast video data may include data, such as score board data included therein.

At step 504, organization computing system 104 may generate tracking data from the broadcast video data. For example, for each game, tracking data system 116 may use one or more computer vision and/or machine learning techniques to generate tracking data from the broadcast video data. To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

At step 506, organization computing system 104 may enrich the tracking data. In some embodiments, enriching the tracking data may include tracking data system 116 merging play-by-play data for an event with the generated tracking data. For example, play-by-play module 120 may receive a play-by-play feed corresponding to the broadcast video data. In some embodiments, the play-by-play data may be representative of human generated data based on events occurring within the game. Tracking data system 116 may merge or align the play-by-play data with the raw generated tracking data (which may include the game and shot clock). In some embodiments, tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

In some embodiments, enriching the tracking data may include tracking data system 116 performing various operations on the aligned tracking system. For example, tracking data system 116 may use the play-by-play data to refine the player and ball positions and precise frame of the end of possession events (e.g., shot/rebound location).

In some embodiments, enriching the tracking data may include tracking data system 116 detecting events, automatically, from the tracking data. For example, tracking data system 116 may include a neural network system trained to detect/refine various events in a sequential manner. For example, tracking data system 116 may include an actor-action attention neural network system to detect/refine one or more of: shots, rebounds, passes, dribbles, and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type.

In some embodiments, enriching the tracking data may include tracking data system 116 enhancing the detected events with contextual information. For example, tracking data system 116 may generate contextual information to enhance the detected events. Exemplary contextual information may include defensive matchup information (e.g., who is guarding who at each frame), as well as other defensive information such as coverages for ball-screens.

In some embodiments, enriching the tracking data may include tracking data system 116 generating an “influence score” for each matchup. The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, enriching the tracking data may include tracking data system 116 using the influence score to assign defender roles for the ball-handler and screener for on-ball screens. In some embodiments, tracking data system 116 may further use the influence score to assign defender roles for the cutter and screener for off-ball screens.

At step 508, organization computing system 104 may pad the tracking data. For example, padding module 122 may create new player representations using mean-regression to reduce random noise in the features. For example, one of the profound challenges of modeling using potentially only 20-30 games of NCAA data per player may be the high variance of low frequency events seen in the tracking data. A highly talented one and done player may, for example, only attempt 50 isolation shots in a career. Such limited amount of data may not be enough to generate a robust mean value for the player's isolation shooting percentage. Therefore, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and tracking and/or event data. In some embodiments, certain player level statistics, such as height, weight, minutes/possessions played, etc. may be excluded.

At step 510, organization computing system 104 may identify a subset of players that are likely to make the NBA. In some embodiments, prediction system 124 may identify the subset of players based on the raw tracking data and the padded tracking data. In some embodiments, each player of the subset of players may have better than a threshold percentage chance (e.g., 40%) of making the NBA.

At step 512, organization computing system 104 may project a range of draft positions for each player of the subset of players. For example, prediction system 124 may classify each player in the subset of players into one of several bins. Each bin may represent a range of draft positions. In this manner, prediction system 124 may identify the chances of each player having a statistical profile of a player picked in various ranges.

FIG. 5B is a flow diagram illustrating a method 550 of predicting player performance in a second league for a player from a first league, according to example embodiments. Method 550 may begin at step 552.

At step 552, organization computing system 104 may identify broadcast video data for a plurality of games in a first league. In some embodiments, the first league may be representative of a league or conference. For example, the first league may be NCAA men's basketball, Big 10 men's basketball, NBA Eastern Conference, NBA Atlantic Division, NBA G-league, international leagues, and the like. In some embodiments, the broadcast video data may be received from tracking system 102. In some embodiments, the broadcast video data for a game may be stored in data store 118. For example, the broadcast video data may be stored in a game file 126 corresponding to a game or event. Generally, the broadcast video data may include a plurality of video frames. In some embodiments, one or more video frames of the broadcast video data may include data, such as score board data included therein.

At step 554, organization computing system 104 may generate tracking data from the broadcast video data in accordance with the techniques disclosed herein. For example, for each game, tracking data system 116 may use one or more computer vision and/or machine learning techniques to generate tracking data from the broadcast video data. To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

At step 556, organization computing system 104 may enrich the tracking data. In some embodiments, enriching the tracking data may include tracking data system 116 merging play-by-play data for an event with the generated tracking data. For example, play-by-play module 120 may receive a play-by-play feed corresponding to the broadcast video data. In some embodiments, the play-by-play data may be representative of automated event data based on tracking data and/or human generated data based on events occurring within the game. Tracking data system 116 may merge or align the play-by-play data with the raw generated tracking data (which may include the game and shot clock). In some embodiments, tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

In some embodiments, enriching the tracking data may include tracking data system 116 performing various operations on the aligned tracking system. For example, tracking data system 116 may use the play-by-play data to refine the player and ball positions and precise frame of the end of possession events (e.g., shot/rebound location).

In some embodiments, enriching the tracking data may include tracking data system 116 detecting events, automatically, from the tracking data. For example, tracking data system 116 may include a neural network system trained to detect/refine various events in a sequential manner. For example, tracking data system 116 may include an actor-action attention neural network system to detect/refine one or more of: shots, rebounds, passes, dribbles, and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type.

In some embodiments, enriching the tracking data may include tracking data system 116 enhancing the detected events with contextual information. For example, tracking data system 116 may generate contextual information to enhance the detected events. Exemplary contextual information may include defensive matchup information (e.g., who is guarding who at each frame), as well as other defensive information such as coverages for ball-screens.

In some embodiments, enriching the tracking data may include tracking data system 116 generating an “influence score” for each matchup. The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, enriching the tracking data may include tracking data system 116 using the influence score to assign defender roles for the ball-handler and screener for on-ball screens. In some embodiments, tracking data system 116 may further use the influence score to assign defender roles for the cutter and screener for off-ball screens.

At step 558, organization computing system 104 may pad the tracking data. For example, padding module 122 may create new player representations using mean-regression to reduce random noise in the features. In some embodiments, padding module 122 may be configured to utilize a padding method, which may be a weighted average between the observed values and sample mean. Padding module 122 may solve for the optimal weighting constant, C, which may best predict the next game of a player's career. Because this approach can be applied to any game level statistic, padding module 122 may be configured to apply such technique to every feature in both box-score and tracking and/or event data. In some embodiments, certain player level statistics, such as height, weight, minutes/possessions played, etc. may be excluded.

At step 560, organization computing system 104 may generate player performance projections in a second league for each player. In some embodiments, the second league may be a target league for which a player may be traded, signed to, etc. Using a specific example, the first league could be the NBA Eastern Conference, and the second league could be NBA Western Conference. In another example, the first league could be G-league, and the second league could be the Chinese Basketball Association. In some embodiments, prediction system 124 may project player performance in the second league by classifying each player into one of several bins. Each bin may represent a tier of player performance (e.g., bin 1=bench player; bin 2=rotation player; bin 3=starter; bin 4=superstar; and the like. In some embodiments, prediction system 124 may project player performance by projecting or estimating season averages for each player in the new league.

FIG. 6 illustrates exemplary statistics from player tracking data collected from international events for two players, according to one or more embodiments. FIG. 6 depicts a first graph 602 of a first player (e.g., Victor Wembanyama) and a second graph 604 of a second player (e.g., Nicola Jovic). The first graph 602 and the second graph 604 are exemplary tracking data accumulated (e.g., as described in step 304).

FIG. 7 depicts a flow diagram illustrating a method 700 of generating DRIP values for a player, according to one or more embodiments. Method 700 may begin at step 702. At step 702, organization computing system 104 may identify a player for which to generate a DRIP value. In some embodiments, organization computing system 104 may identify a player for which to generate a DRIP value, responsive to receiving a request from a user of client device 108. In some embodiments, organization computing system 104 may identify a player for which to generate a DRIP value automatically, such as at a preset time during the day, in which organization computing system 104 generates DRIP values for each player in the league.

At step 704, organization computing system 104 may identify broadcast video data for a plurality of games in a first league. In some embodiments, the first league may be representative of a league or conference. For example, the first league may be NCAA men's basketball, Big 10 men's basketball, NBA Eastern Conference, NBA Atlantic Division, NBA G-league, international leagues, and the like. In some embodiments, the broadcast video data may be received from tracking system 102. In some embodiments, the broadcast video data for a game may be stored in data store 118. For example, the broadcast video data may be stored in a game file 126 corresponding to a game or event. Generally, the broadcast video data may include a plurality of video frames. In some embodiments, one or more video frames of the broadcast video data may include data, such as score board data included therein.

At step 706, organization computing system 104 may generate tracking data from the broadcast video data in accordance with the techniques disclosed herein. For example, for each game, tracking data system 116 may use one or more computer vision and/or machine learning techniques to generate tracking data from the broadcast video data. To generate the tracking data from the broadcast data, tracking data system 116 may map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track the ball across all frames. In some embodiments, tracking data system 116 may further utilize optical character recognition techniques. For example, tracking data system 116 may utilize optical character recognition techniques to extract score information and time remaining information from a digital scoreboard of each frame.

At step 708, organization computing system 104 may enrich the tracking data. In some embodiments, enriching the tracking data may include tracking data system 116 merging play-by-play data for an event with the generated tracking data. For example, play-by-play module 120 may receive a play-by-play feed corresponding to the broadcast video data. In some embodiments, the play-by-play data may be representative of automated event data based on tracking data and/or human generated data based on events occurring within the game. Tracking data system 116 may merge or align the play-by-play data with the raw generated tracking data (which may include the game and shot clock). In some embodiments, tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

In some embodiments, enriching the tracking data may include tracking data system 116 performing various operations on the aligned tracking system. For example, tracking data system 116 may use the play-by-play data to refine the player and ball positions and precise frame of the end of possession events (e.g., shot/rebound location).

In some embodiments, enriching the tracking data may include tracking data system 116 detecting events, automatically, from the tracking data. For example, tracking data system 116 may include a neural network system trained to detect/refine various events in a sequential manner. For example, tracking data system 116 may include an actor-action attention neural network system to detect/refine one or more of: shots, rebounds, passes, dribbles, and possessions. Tracking data system 116 may further include a host of specialist event detectors trained to identify higher-level events. Exemplary higher-level events may include, but are not limited to, postups, drives, isolations, ball-screens, handoffs, off-ball-screens, the like. In some embodiments, each of the specialist event detectors may be representative of a neural network, specially trained to identify a specific event type.

In some embodiments, enriching the tracking data may include tracking data system 116 enhancing the detected events with contextual information. For example, tracking data system 116 may generate contextual information to enhance the detected events. Exemplary contextual information may include defensive matchup information (e.g., who is guarding who at each frame), as well as other defensive information such as coverages for ball-screens.

In some embodiments, enriching the tracking data may include tracking data system 116 generating an “influence score” for each matchup. The influences score may capture the influence a defender may have on each offensive player on a scale of 0-100. In some embodiments, the value for the influence score may be based on basketball defensive principles, such as, but not limited to, proximity to player, distance from basket, passing lanes, lanes to the basket, and the like.

In some embodiments, enriching the tracking data may include tracking data system 116 using the influence score to assign defender roles for the ball-handler and screener for on-ball screens. In some embodiments, tracking data system 116 may further use the influence score to assign defender roles for the cutter and screener for off-ball screens.

At step 710, organization computing system 104 may determine whether the player has played a game in a given league (e.g., the NBA). For example, padding module 122 may determine whether any box-score or play-by-play data is associated with the player in data store 118. In a further example, padding module 122 may determine whether any enriched tracking data is associated with the player in data store 118. If, at step 710, padding module 122 determines that the player has not yet played a game in the league, then method 700 proceeds to step 712.

At step 712, organization computing system 104 may generate an adjusted game one metric for the player. For example, padding module 122 may utilize attributes, such as but not limited to height, weight, age, and/or draft pick number, to predict metrics corresponding to a first game of the player's career. To generate the adjusted game one metric, padding module 122 may utilize a rookie model, generated using previous rookie data from data store 118. Using the rookie model, padding module 122 may generate an adjusted game one estimate for each statistical category.

If, however, at step 710, padding module 122 determines that the player has played a game in the league, then method 200 proceeds to step 714.

At step 714, organization computing system 104 may generate time series data points for the player. For example, padding module 122 may generate time series data points for the player using one or more of a padding technique or bayes filters to achieve a baseline “now-cast” for each statistic a player accumulates. To generate the time series data points for the player, padding module 122 may use all available data (e.g., tracking data, event data, etc.) on the player, starting with the rookie priors.

At step 716, organization computing system 104 may generate player position data for the player. For example, play-by-play module 120 may estimate the player's current projected “game position” based on one or more statistical markers. Exemplary statistical markers may include, but are not limited to, passing and rebounding, as provided in all available data (e.g., tracking data, event data, etc.). In some embodiments, as output, play-by-play module 120 may generate a value representing the player's position. For example, play-by-play module 120 may generate a value within the range of 0-100, where 0 may represent the most “true point guard-like” and 100 is the most “true center-like.”

At step 718, organization computing system 104 may generate next game projections for the player. For example, prediction system 124 may receive tracking data, event data, rookie priors for the player, the time series data points for the players, the player position data, the player box score data, the player play-by-play data, and the like as inputs. Prediction system 124 may run the inputs through gradient-boosted decision trees to generate next-game projections for each player.

At step 720, organization computing system 104 may generate DRIP values for the player based on the next game projections. For example, prediction system 124 may take each statistical output (e.g., generated at step 712) and may project player contribution to a team's plus/minus per 100 possessions on both offense and defense. In some embodiments, adjusted plus/minus may be used as the target. The final output may be representative of a player's DRIP value. In some embodiments, prediction system 124 may generate three output values: a DRIP value for offense, a DRIP value for defense, and a total DRIP value.

The DRIP value may be displayed on a user device (e.g., client device 108) within an application (e.g., application 130). In displaying the DRIP value(s) on the user device, the user device may include a corresponding user profile associated with the application. The user profile information may include preference and/or setting information relating to the user. Preference and/or setting information may include, but not limited to, displaying, organizing, and arranging content. The user profile may include predefined settings as to how certain information is to be displayed within an application. For example, information may be presented in one or more formats based on the data type. The information may be presented in a first format (e.g., an information format including text and/or character strings), a second format (e.g., image and/or audio), or a combination thereof. The application may receive the DRIP value(s) and the application may convert the DRIP value(s) into a format based on the user profile information.

According to embodiments disclosed herein, data used for one or more models may include box score and plus minus data relating to prior years (e.g., 2012). Box score data may be included for each player who played or participated in each game during that time period. For certain leagues (e.g., NBA and WNBA), regular season game data may be used for the purpose of training the one or more models. For other leagues (e.g., CBK and WCBK), all games, regular season and playoffs, may be used for the purpose of training the one or more models.

For a full data league (e.g., NBA), data starting from the 2012-2013 season to the 2019-2020 season may be used as the training data for the RAPM model. This data includes 203, 124 player games for the rates models and 2,258 player season for the RAPM model. For partial data leagues (e.g., WNBA), data starting from the 2012-2013 season to the 2019-2020 season may be used as the training data for the RAPM model. This data includes 34,366 player games for the rates models. The RAPM model may not be trained for the partial data leagues when no RAPM data is available, which may include fouls drawn, times blocked, +/−values for games that may not include play-by-play data. Additional models are generated and trained as discussed in further detail below.

A fouls drawn model may include a linear regression model to model fouls drawn per 100 possessions. A times blocked model may include a linear regression model to model times blocked per shot attempt. A +/− model may include a calculation of each player's +/− for a given game when play-by-play data is available. If play-by-play data is not available, a model is generated using the number of points a player's team scores when that player is on the court using an MLP regression model. Features of the fouls drawn model, the times blocked model, and the +/− model may include, but are not limited to, height, 3-point field goal rate (including attempts and makes), 2-point field goal rate (including attempts and makes), points, assists, blocks, or the like. Game 1 predictions may use a light GBM regression model (as described in detail above) for each rates stats prediction. A target value may include a regressed value for each player based on their respective first season in the league. Features of the game 1 predictions model may include, but are not limited to, height, weight, draft pick, age, rookie, previous career games played, or the like. In some instances, if the player played games prior to the date of the database (e.g., 2012-2013 season), the game 1 prediction may include the player's first game since 2012. The purpose of the game 1 prediction model may be to obtain an initial prediction for each player that does not have a sample of games in a specific league. All of the models discussed herein may use the tracking data or event data as inputs. Alternatively, instead of using a game 1 prediction model, a DRIP value of a player may be used, where the DRIP value is a DRIP value generated from a player's performance in a previous league. For example, if a player is preparing to play their first game in the NBA, the player will not have a sample of games from which data may be obtained. Instead, the DRIP value generated from the player's performance in a previous league (here, NCAA basketball) may be used as an input to generate the player's DRIP value in the player's new league (here, the NBA).

A filter model may include using initial values from the game 1 predication model to then determine how much of a means regression for each rate stat may be required for that metric. A padded model may include using a similar method as the filter model with the addition of using the league average for each stat as a prior and regressing the value to the league average. This regression may cause the padded model to be more accurate and conservative. For both the filter model and the padded model, a potential means regression weight pick may be used with the lowest weight sum error as the final means regression amount.

For example, the filter model may take a player's game performance and regress it to a prior, where the prior may include the player's filter rates prediction from the previous game. As an example, using the assists for the first 3 games for Victor Wembanyama, a prior value of 1.86 and a filtered weight value (mean regression samples) is 733. During that time, Wembanyama had 3.87 assists in 51.7 possessions. The filtered rates prediction is: [(prior assists per 100*filter weight value)+(actual assists per 100*actual possessions)]/(filter weight value+actual possessions) or [(1.86*733)+(3.87*51.7)]/(733+51.7)=1.99. For the next game, the 1.99 result from the previous output may become the new prior. In Wembanyama's next game having 1.54 assists per 100 in 64.8 possessions, the filtered rates prediction now becomes [(1.99*733)+(1.54*64.8)]/(733+64.8)=1.95.

In another example, the padded model may take a player's career performance and regress it to a prior. The prior for the player may be the league average projection for that stat. As an example, using the assists for the first 3 games for Victor Wembanyama, the prior value for Wembanyama is 4.88 and the filter weight value (mean regression samples) is 64 (for this example, the denominator is player possessions played). In Wembanyama's first game, he had 3.87 assists in 51.7 possessions. The new filter projection is: [(prior assists per 100*filter weight value)+(actual assists per 100*actual possessions)]/(filter weight value+actual possessions) or [(4.88*64)+(3.87*51.7)]/(64+51.7)=4.43. For the next game, the 4.88 remains the prior for the calculation of his career average assists per 100 possessions. In his next game, he had 1.54 assists per 100 in 64.8 possessions. Wembanyama's career average assists per 100 is 2.574 and the total possessions is 116.5. The filtered rates prediction for Wembanyama's 3_{rd} game is now: [(4.88*64)+(2.574*116.5)]/(64+116.5)=3.39.

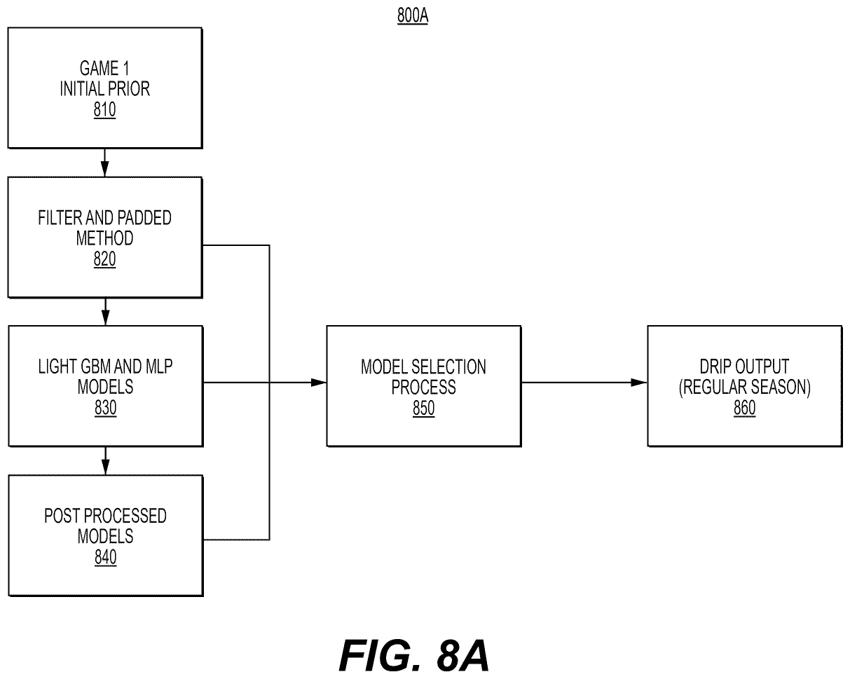

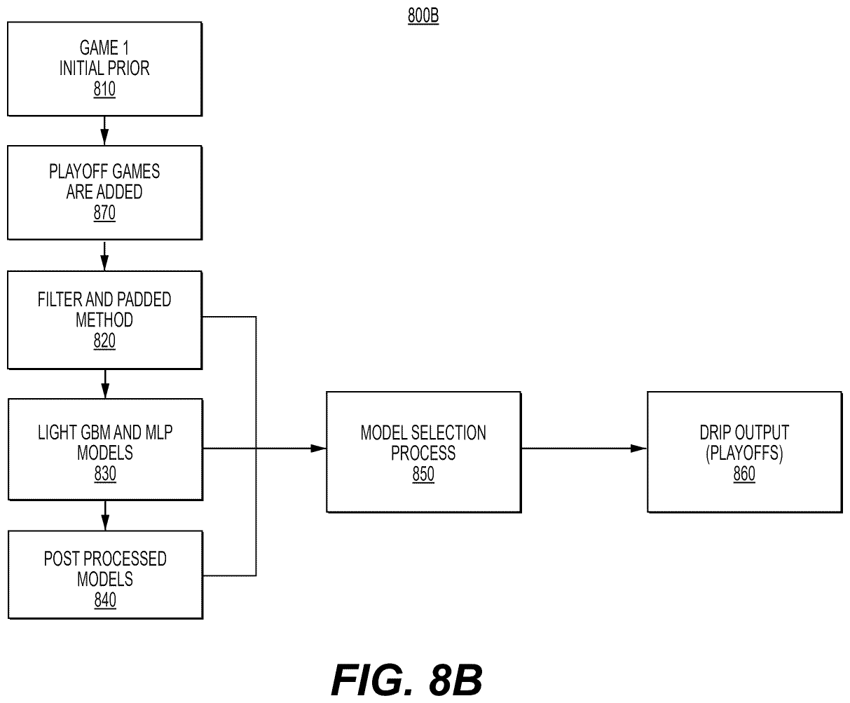

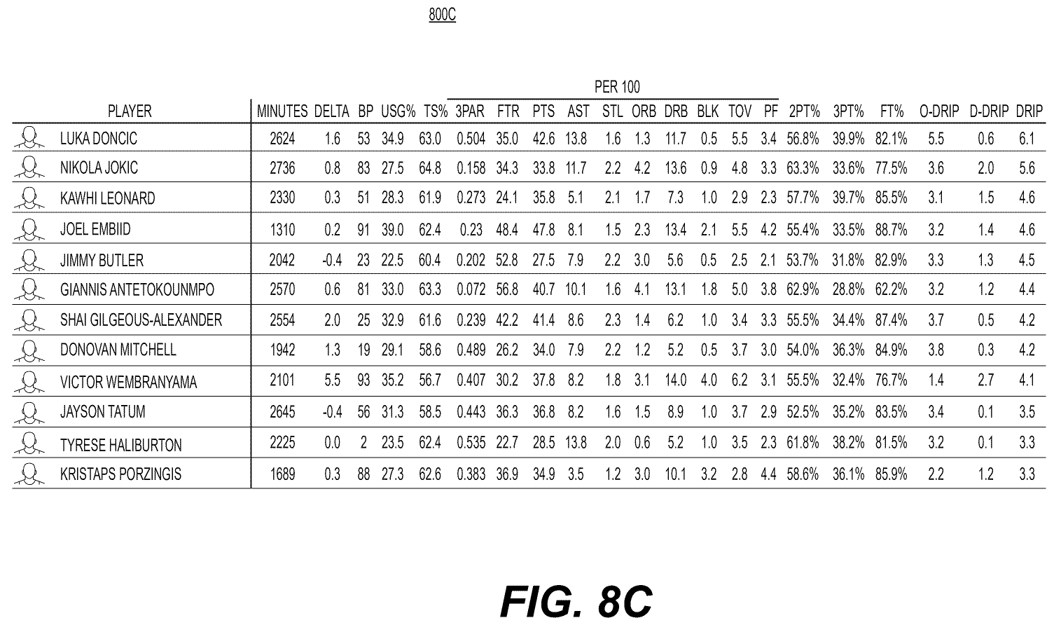

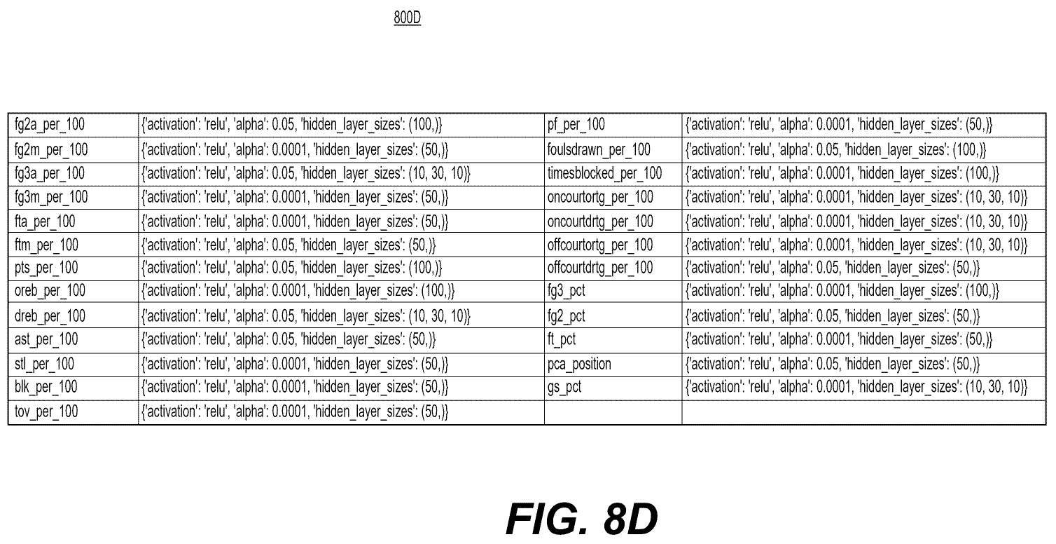

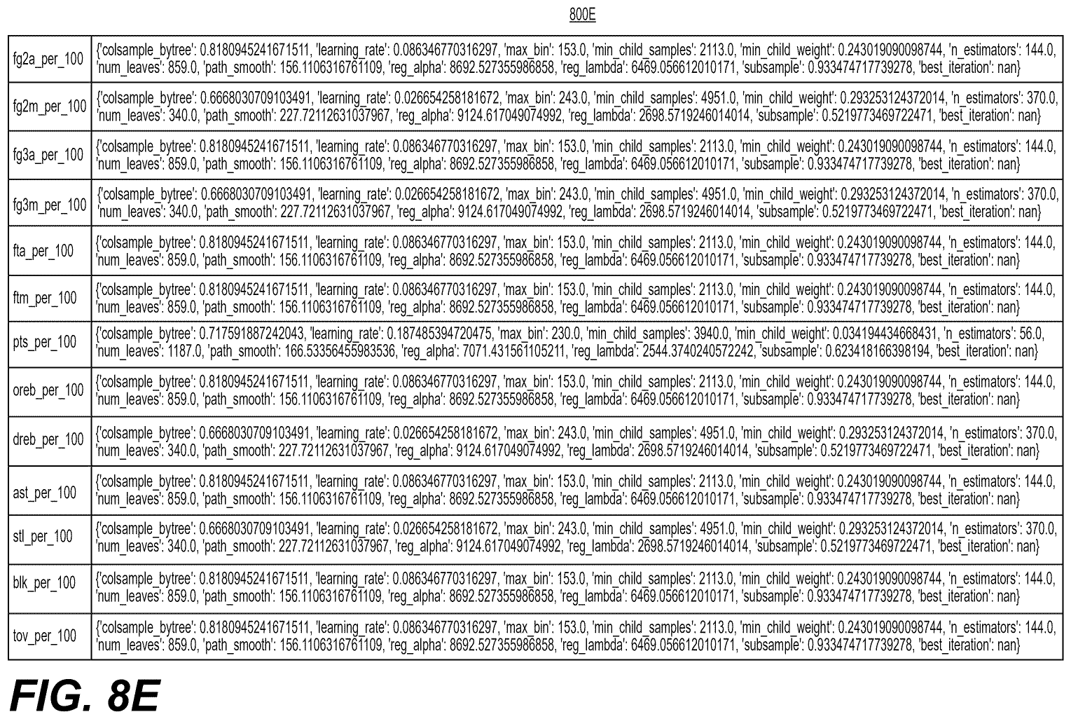

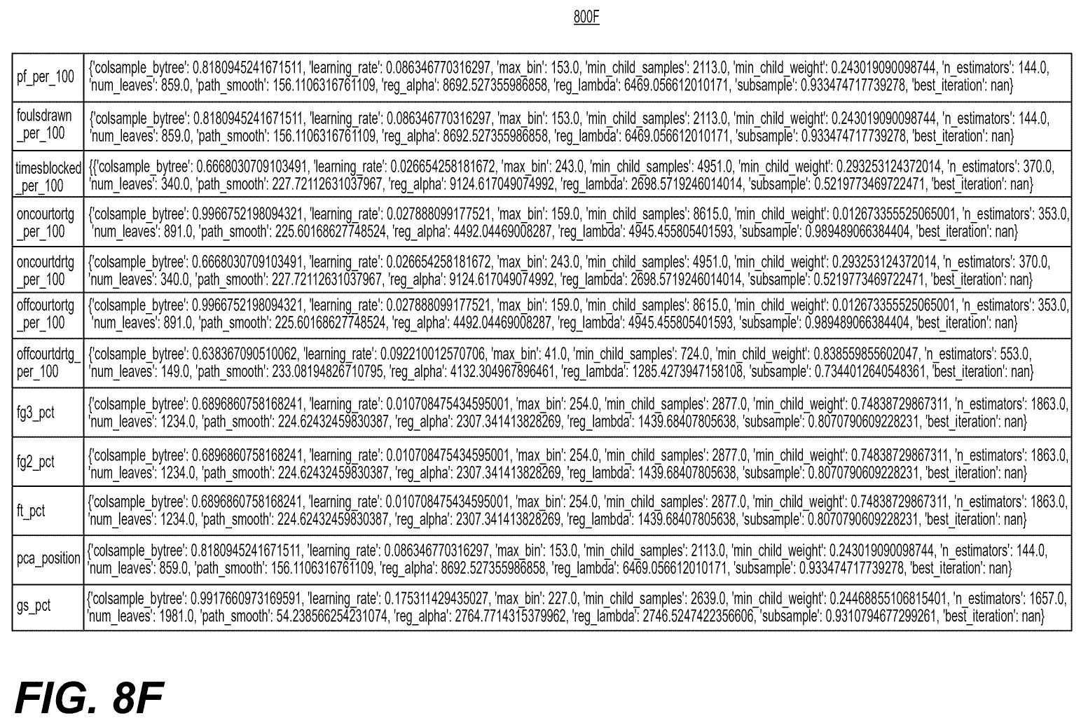

FIGS. 8A and 8B depict exemplary flow diagrams illustrating a generation of DRIP values for a player, according to one or more embodiments. Flow 800A depicts an exemplary flow of generating a DRIP value for a player during the regular season. Flow 800A may start at step 810, which may be similar to step 710 of method 700, as described above with respect to FIG. 7. It is appreciated that flow 800A focuses on generating DRIP values by analyzing data already collected, as described in FIG. 7. Hence, flow 800A may also include steps similar to steps 702, 704, 706, and 708 when collecting, for example, tracking data for a selected player. Step 810 may determine whether the player has played a game in a full data league (e.g., the NBA) and output a value. Step 810 may utilize the game 1 prediction model or DRIP value generated from a player's performance in a previous league, as described above. The output value may be in a first format, where the first format may include an informational format (e.g., text and/or character strings) based on the manually inputted and/or automatically generated data.

At step 820, in response to the determination in step 810, flow 800A may take the output of the game 1 prediction model or DRIP value generated from a player's performance in a previous league for use in a filter model and/or a padded model with the value received from step 810. The filter model may determine an amount of regression each rate stat requires to generate a reasonable estimate for that particular metric. The filter model may take a player's game performance and regress it to a prior, where the prior may be the player's filter prediction from the previous game. In addition, the filter model may use a few (e.g., 3) prior games of the player to predict a future value. A padded model may be similar to the filtered model but may include a league average for the stats as prior and regression values to the league average. The padded model may take a player's career performance and regress it to a prior value, where the prior value may be the league average projection for that stat. In addition, the padded model may use a few prior games of the player to predict a future value. For both the filter model and the padded model a potential mean regression weight with the lowest weight sum error as the final means regression amount may be predetermined. The filter model and/or the padded model may include outputs in a second format. The second format may include a machine-readable format that may be provided as input to one or more machine-learning models. The second format may include, for example, a JSON file, XML file, or the like.

At step 830, the outputs from the filter model and the padded model at step 810 may be used to create MLP and light GBM regression models to predict box score stats. The predicted box score stats may be used in steps 714 and 716 with respect to FIG. 7 as described above. The MLP regression model may use all features from both the filter model and the padded model to predict all values of the box score stats. The light GBM regression model may use a sub-set of features from both of the filter model and the padded model to predict the values of the box score stats. The MLP and/or the light GBM regression models may be in the second format.

At step 840, the outputs from the MLP model and the light GBM model may be used by the post-processing rate model. The post-processing rates model may run the MLP model and the light GBM model through the filter model, described above, with a target being the individual game residual for each value. The post-processing rates model may smooth out the projections to reduce the jumps in game-by-game predictions. In addition, the post-processing rate model may ensure that individual players are not over/under projected.

At step 850, based on all of the value outputs from each step above (e.g., step 820, step 830, and step 840), the most accurate value is selected for use as the box scores stats. The selected box score stats may then be used at step 860 to determine the DRIP output values as similarly described in step 720 with respect to FIG. 7 above. The DRIP output values may be a third format. The third format may include an information format (e.g., text, character strings, and/or graphical representations) based on the received output data from the above steps.

Additionally or alternatively, while not shown, flow 800A may generate a DRIP value of a player during the post season (e.g., playoffs). Here, team rating adjusted for conference and roster (TRACR) ratings are used to adjust the output value(s) of Step 810 to generate opponent neutralized rate score stats. Briefly, TRACR is a net efficiency metric that measures how good a team performs offensively and defensively relative to an average team in a given league (e.g., NBA), similar to a replacement-level player. TRACR may be adjusted after each game, rewarding teams that do well against top teams and punishing teams that perform poorly against teams they should have done well against. The opponent neutralized rate score stats are then input into the models described (e.g., performing steps 820, 830, and 840). At step 850, based on all of the value outputs from each step above (e.g., step 820, step 830, and step 840), the most accurate value is selected for use as the post-season box scores stats. The selected post-season box score stats may then be used at step 860 to determine the DRIP output values as similarly described in step 720 with respect to FIG. 7 above. Furthermore, the selected post-season box score stats may be put through a linear regression stat to determine the weighting of each post-season box score stat, meaning that different post-season box score stats (e.g., field goals, assists, etc.) may be given different weights when determining the DRIP output values.

FIG. 8B depicts exemplary flow 800B depicting another exemplary flow of generating a DRIP value for a player during the post season (e.g., playoffs) without using TRACR ratings. Flow 800B may be substantially similar to flow 800A, therefore similar reference numerals may be used to describe similar steps within each flow, except as otherwise described herein. It is appreciated that flow 800B focuses on generating DRIP values by analyzing data already collected, as described in FIG. 7. Hence, flow 800B may also include steps similar to steps 702, 704, 706, and 708 when collecting, for example, tracking data for a selected player. Flow 800B may start with step 810 as similarly described above with respect to flow 800A. However, the output of step 810 in flow 800B are received at step 870. At step 870, playoff games information is included and may be utilized by the models in steps 820, 830, and 840. However, step 870 is limited to generating DRIP information in post-season games. When the next regular season begins, step 870 may be removed as necessary.

Flow 800B may continue as described in flow 800A, performing steps 820, 830, and 840, with the additional information from step 870. Steps 850 and 860 may be performed as similarly described with respect to flow 800A.

FIGS. 8C-81 depict exemplary input and output values for generating a DRIP value for a player, according to one or more embodiments. FIG. 8C may include DRIP output values 800C for a set of players within a full data league (e.g., NBA) using the flow diagrams as described with respect to FIGS. 7 and 8A. FIG. 8D depicts a table 800D showing MLP model best rate parameters that were selected for each rate stat. Similarly, FIGS. 8E and 8F depict tables 800E, 800F showing Light GBM model best rates that were selected for each rate stat. FIGS. 8G and 8H depict lists 800G, 800H showing the post processing weights given for the MLP model and the post processing weights given for the Light GBM model for each rate stat selected. FIG. 81 depicts list 8001 showing the final rates model selection process. For example, the final rates model selection process may include the use of all six models (e.g., filter, padded, MLP, light GBM, MLP post processing, and Light GBM post processing) which may then be evaluated using weighted R2 scores to determine the most accurate model for each rate stat. The best score for each model may then be used as an input for the DRIP model.

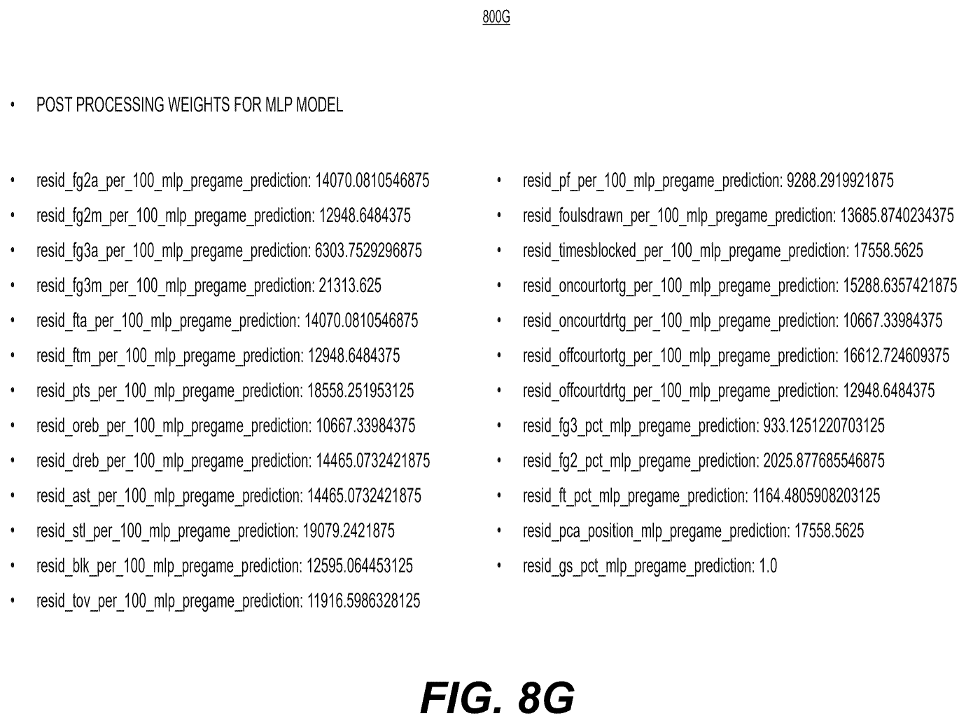

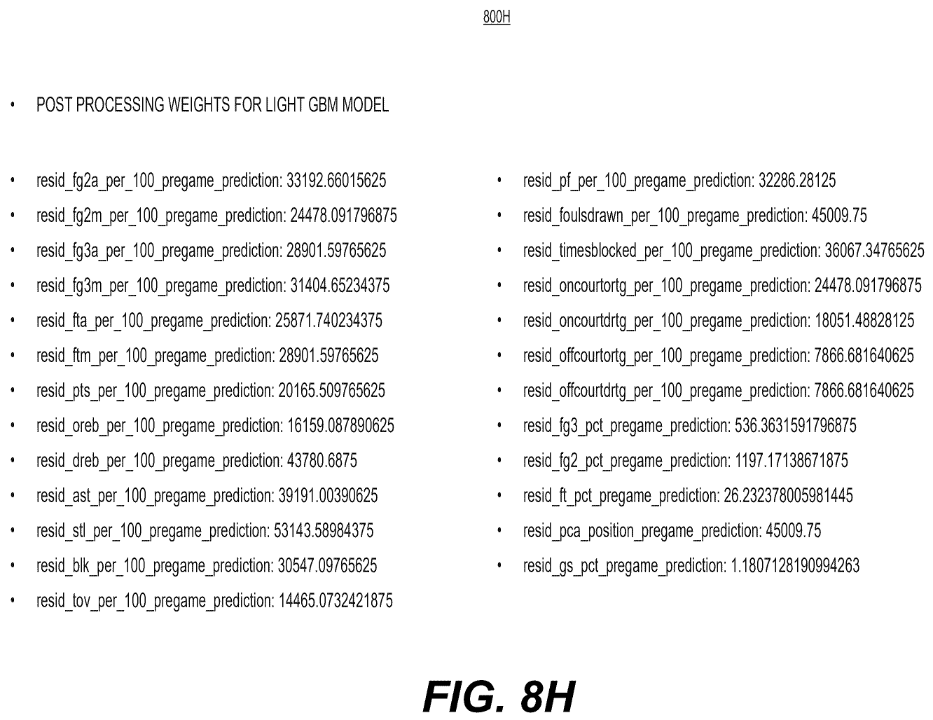

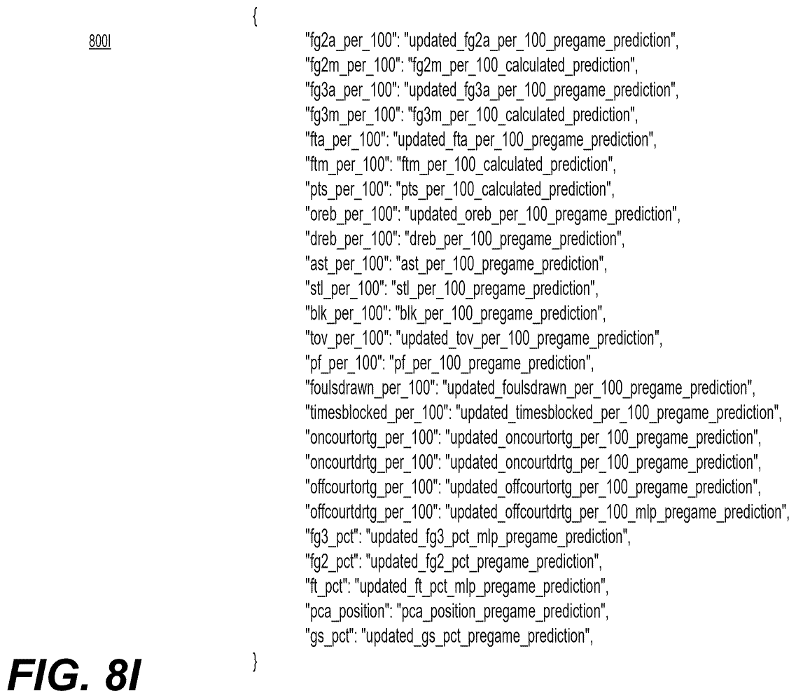

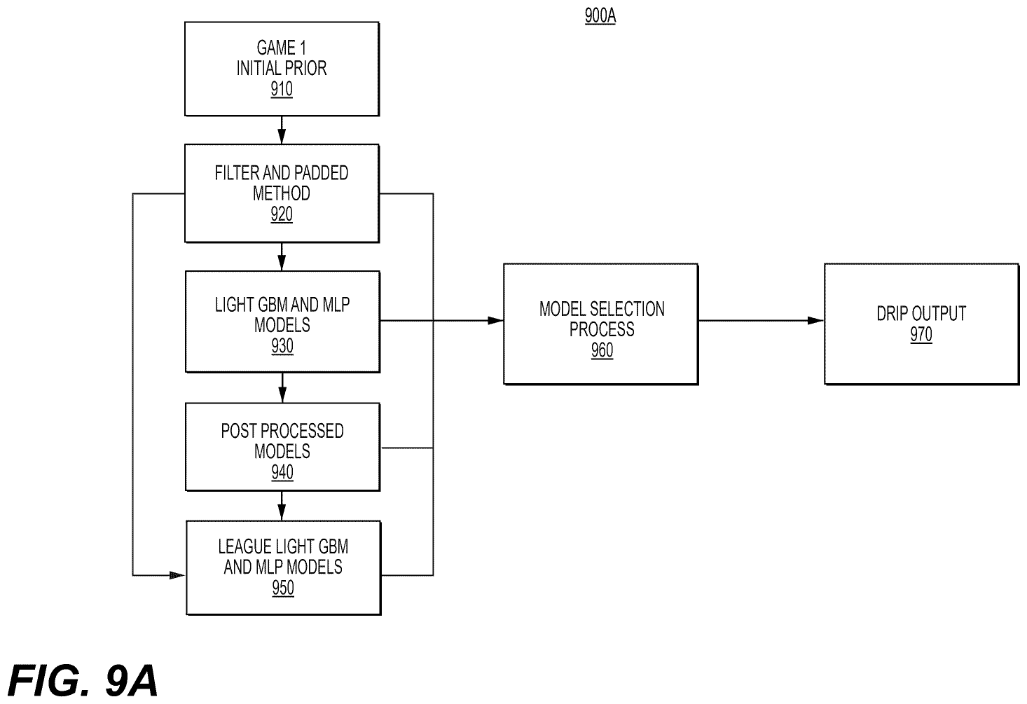

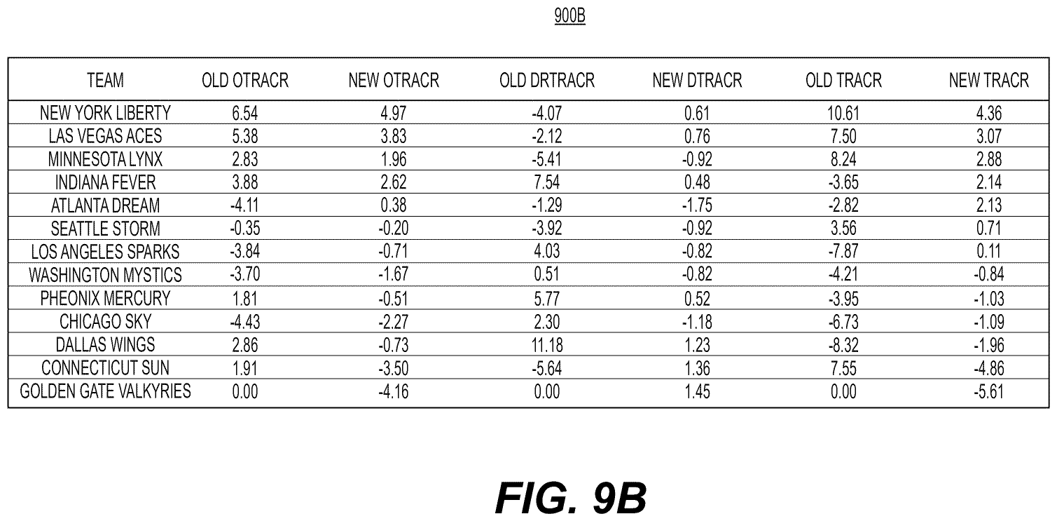

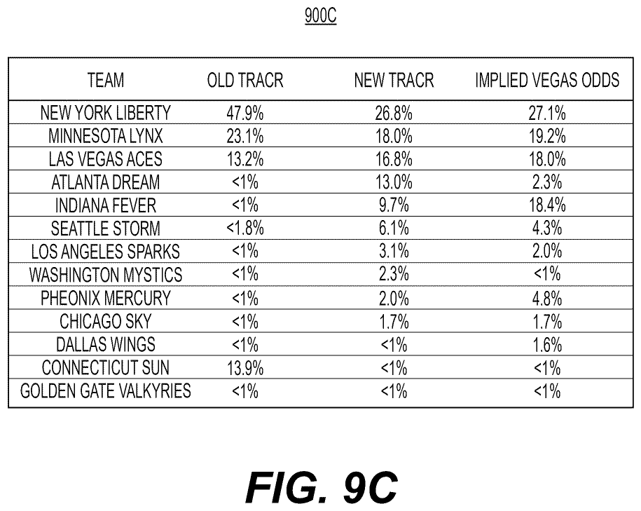

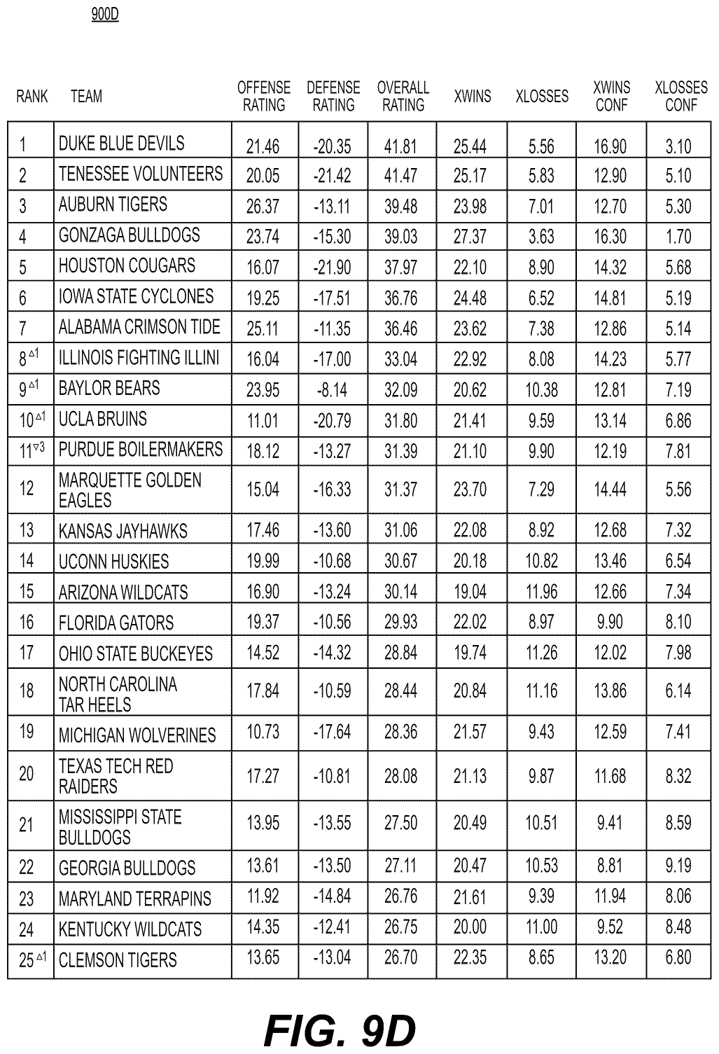

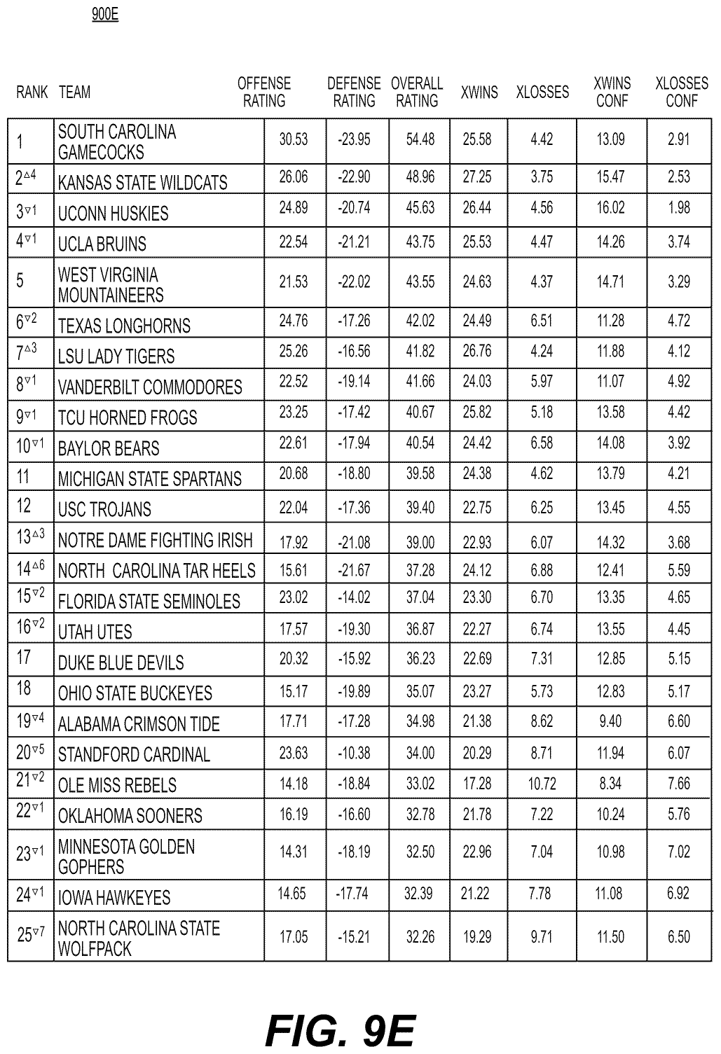

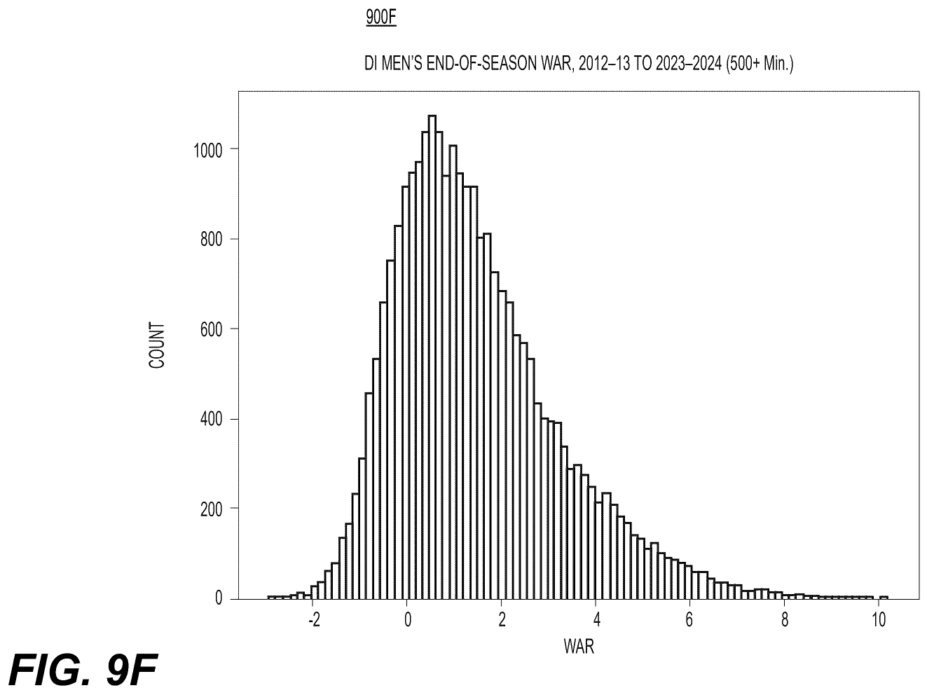

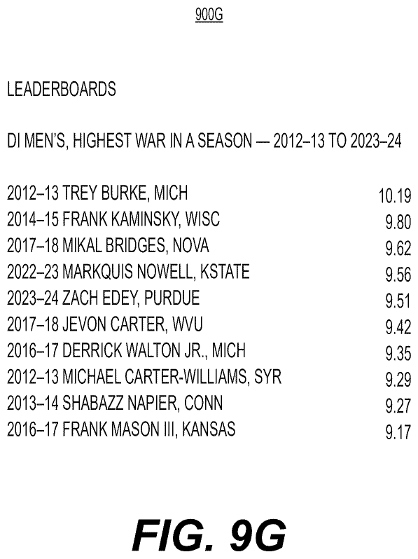

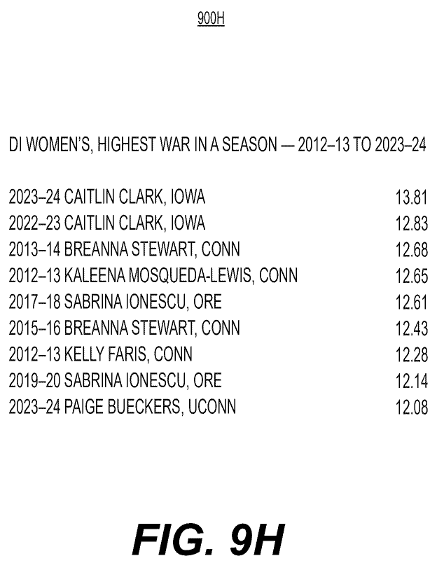

FIG. 9A depicts an exemplary flow diagram illustrating a generation of DRIP values for a player, according to one or more embodiments. Flow 900A depicts an exemplary flow of generating a DRIP value for a player during the regular season for partial data leagues (e.g., WNBA, CBK, WCBK). It is appreciated that flow 900A focuses on generating DRIP values by analyzing data already collected, as described in FIG. 7. Hence, flow 900A may also include steps similar to steps 702, 704, 706, and 708 when collecting, for example, tracking data for a selected player. Flow 900A may start at step 910, which may be similar to step 710 of method 700, as described above with respect to FIG. 7. Step 910 may determine whether the player has played a game in a partial data league and output a value using the game 1 prediction model or DRIP value generated from a player's performance in a previous league as described in detail above. The output value may be in a first format, where the first format may include an informational format (e.g., text and/or character strings) based on the manually inputted and/or automatically generated data.

At step 920, in response to the determination in step 910, flow 900A may input the game 1 prediction model value or DRIP value generated from a player's performance in a previous league to a filter model and/or a padded model. The filter model may determine an amount of regression each rate stat requires to generate a reasonable estimate for that particular metric. The filter model may take a player's game performance and regress it to a prior, where the prior may be the player's filter prediction from the previous game. In addition, the filter model may use a few prior games of the player to predict a future value. A padded model may be similar to the filtered model but may include a league average for the stats as prior and regression values to the league average. The padded model may take a player's career performances and regress it to a prior value, where the prior value may be the league average projection for that stat. In addition, the padded model may use a few prior games of the player to predict a future value. For both the filter model and the padded model, a potential mean regression weight with the lowest weight sum error as the final means regression amount may be predetermined. The filter model and/or the padded model may include outputs in a second format. The second format may include a machine-readable format that may be provided as input to one or more machine-learning models. The second format may include, for example, a JSON file, XML file, or the like.

At step 930, the outputs from the filter model and the padded model at step 910 may be used to create a first MLP and a first light GBM regression models to predict box score stats. The predicted box score stats may be used in steps 714 and 716 with respect to FIG. 7 as described above. The first MLP regression model may use all features from both the filter model and the padded model to predict all values of the box score stats. The first light GBM regression model may use a sub-set of features from both the filter model and the padded model to predict the values of the box score stats. The first MLP and/or the first light GBM regression models may be in a third format. The third format may include a machine-readable format that may be provided as input to one or more machine-learning models. The third format may include, for example, a JSON file, XML file, or the like.

At step 940, the outputs from the first MLP model and the first light GBM model may be used by the post-processing rate model. The post-processing rates model may run the first MLP model and the first light GBM model through the filter model, described above, with a target being the individual game residual for each value. The post-processing rates model may smooth out the projections to reduce the jumps in game-by-game predictions. In addition, the post-processing rate model may ensure that individual players are not over/under projected. The post-processing rates model may be in a fourth format. The fourth format may include a machine-readable format that may be provided as input to one or more machine-learning models. The fourth format may include, for example, a JSON file, XML file, or the like.

At step 950, a second MLP and a second light GBM models are trained and may be used with flow 900A. The second MLP and the second light GBM models may be partial data league specific (e.g., WNBA, CBK, WCBK). These models may be trained in order to determine statistics (e.g., rate stats) not available in the full data league model as described in FIGS. 8A and 8B. The second MLP and the second light GBM models may be in a fifth format. The fifth format may include a machine-readable format that may be provided as input to one or more machine-learning models. The fifth format may include, for example, a JSON file, XML file, or the like. The outputs from the second MLP and the second light GBM models may be adjusted to ensure the average for each projected rate stat substantially matches with the average for the NBA. In addition, with the team schedules in the CBK and WCBK being much more disparate than that of the NBA and WNBA, a further adjustment to each player's game level DRIP value to account for an opponent TRACR rating. The TRACR rating may be on a scale of points per 100 possessions above or below the league average, prior to the current game.

At step 960, based on all of the value outputs from each step above (e.g., step 920, step 930, step 940, and step 950) the most accurate value is selected for use as the box scores stats. The selected box score stats may then be used at step 970 to determine the DRIP output values as similarly described in step 720 with respect to FIG. 7 above. The DRIP output values may be a sixth format. The sixth format may include an information format (e.g., text, character strings, and/or graphical representations) based on the received output data from the above steps.

In one embodiment, the DRIP model (e.g., FIG. 7) may allow for determining the WAR for each team and/or individual player. To determine a WAR value, the projected box score stats (e.g., Step 718 of method 700) may be replaced with actual box score stats. In response to a new DRIP value using actual box score stats, a cumulative value is determined and converted from points to wins. Determining a WAR value may be performed for any league (e.g., NBA, WNBA, CBK, and WCBK).

In addition to WAR, TRACR may play an important role. As previously mentioned, TRACR is a net efficiency metric that measures how good a team performs offensively and defensively relative to an average team in a given league (e.g., CBK, Division I), similar to a replacement-level player. TRACR may be adjusted after each game, rewarding teams that do well against top teams and punishing teams that perform poorly against teams they should have done well against. When determining a WAR value for a team and/or individual player, TRACR ratings may be used to adjust WAR values based on possession. For example, if a player and/or team plays two games, and the first game involves 50 possessions against a +3 team (where +3 is the team's TRACR rating) and the second game involves 50 possessions against a-3 team, the TRACR adjustment would be 0.

Each team's TRACR may be adjusted on a per-100 possession level. For example, if Team A has a TRACR of 30 plays and Team B that has a TRACR of 0, Team A should outscore Team B by about 0.3 points per possession. If Team A averages 70 possessions, then it would outscore Team B by 21 points on average. Each player's WAR may be broken down game-by-game, with each game adjusted by their opponent's TRACR entering that day. Additionally, DRIP values for each player on a given team (e.g., Team A, Team B, etc.) may further be used to improve the accuracy of TRACR ratings. FIG. 9B illustrates an exemplary output 900B for WNBA teams of offensive TRACR ratings, defensive TRACR ratings, and total TRACR ratings not improved with DRIP values (i.e., Old OTRACR, Old DTRACR, and Old TRACR) and offensive TRACR ratings, defensive TRACR ratings, and total TRACR ratings improved with DRIP values (i.e., New OTRACR, New DTRACR, and New TRACR). FIG. 9C illustrates an exemplary output 900C for WNBA Championship odds based on TRACR ratings not improved with DRIP values (i.e., Old TRACR) and TRACR ratings improved with DRIP values (i.e., New TRACR).

FIGS. 9D and 9E depict tables 900D, 900E showing exemplary TRACR outputs, according to example embodiments. FIGS. 9D and 9E depicts exemplary TRACR outputs for teams within a partial data league (e.g., CBK and WCBK).

FIG. 9F depicts an exemplary VAPR graphic, according to example embodiments. Graphic 900F may include players who played at least 500 minutes in a given season, the median VAPR is about 0.19 while the median end-of-season WAR is roughly 1.15. Not all players play the same number of minutes or even the same number of games due to various tournaments throughout the season. An additional WAR per 40 games calculation may be included, which provides a player's WAR if their team has played 40 games. For example, if a player's WAR is 5 and their team played 30 games, their WAR per 40 games would be 5/30*40=6.67.

A similar WAR metric is used in baseball, as one of the premier advanced metrics in the sport. In baseball, WAR may break down a player's value by measuring how many wins they are worth relative to a replacement-level player at the same position (where a replacement-level player is the equivalent of a Minor League replacement or a fill-in free agent). The positional aspect is key, and players may differ despite having the same numbers. For example, if a second baseman and a left fielder have the same overall production (e.g., hitting, fielding, running, etc.), the second baseman may likely have a better WAR due in part to the value of a replacement-level second baseman may be lower than the value of a replacement-level left fielder, since second base may be a more difficult position to play.

Positions may still be a factor in the present CBK and WCBK WAR metrics. For example, instead of classifying players by traditional basketball positions like guard, forward, or center, each player may be classified through numbers that may better determine what position they might be. Positions in college basketball are much more arbitrary than in baseball or even compared to the NBA, therefore modifying a method as described above may better capture how a player performs relative to a replacement-level player of their caliber.

For example, a classification may cluster players by their offensive and defensive rebounds, blocks, and assists into a spectrum that may align with an expected position. This may assist in identifying players that may be listed as one position but play like another, for example, Nikola Jokic or Robbie Avila (centers who play like guards). In addition, the classification clusters may assist to distinguish two players that are traditionally the same position but play differently, for example Zach Edey (center who plays like a center) versus Johni Broome (center who plays like a guard). In doing so, a comparison of all players' WAR collectively is possible instead of looking at WAR by position.

In this manner, not only are the players compared relative to a replacement-level player, but their WAR may be adjusted by the level of play. For example, in college basketball, there may be a much larger disparity in talent level to the point where scaling may be used to estimate a player's true talent. For example, a player having a 30-point game against a Top 25 team may be more impressive than the same player having a 30-point game against a team that will manage a few wins over the course of the season.

It may also be important to note that the disparity in women's college basketball is even larger than in men's. The undefeated 2023-24 South Carolina squad finished the season with a TRACR rating of 62.5, 10 points higher than any other DI school. TRACR expected the Gamecocks, who averaged about 72 possessions per game, to outscore an average team by 45 points. Thus, needing an opponent adjustment is critical. This may also be why, on average, there are fewer upsets in the women's NCAA Tournament compared to the men's.

FIG. 9G depicts exemplary WAR outputs, according to example embodiments. FIG. 9G depicts the highest WAR metrics in a season for seasons between the 2012-2013 season to the 2023-2024 season for Men's College Basketball. It should not come as any surprise that almost all the players on this list took March Madness by storm and helped their team go further in the tournament. Whether it was Trey Burke's clutch scoring in 2013, Frank Kaminsky leading a talented Wisconsin squad over undefeated Kentucky in the Final Four, or Zach Edey's throughout the entire 2023-24 season en route to a runner-up performance for Purdue.

Table 900G may also illustrate how WAR encapsulates more than just scoring, otherwise the top 10 would comprise of players like Trae Young, Doug McDermott or even Chris Clemons. Table 900G may display a measure of how valuable a player is in all aspects relative to a replacement-level player in Division I. The WAR metric understands the offensive value beyond scoring, like Markquis Nowell's 19-assist game in the Sweet Sixteen in 2023 or Michael Carter-Williams averaging 7.3 assists and 2.8 steals in his final season with Syracuse.

WAR may incorporate features on the other side of the ball as well. For example, Mikal Bridges, Zach Edey and Jevon Carter were excellent players offensively but were also as valuable defensively. Carter was even named the Naismith Defensive Player of the Year in 2017-18. WAR may factor in every part of a player's game, not just one aspect.

FIG. 9H depicts exemplary WAR outputs, according to example embodiments. FIG. 9H depicts the highest WAR metrics in a season for seasons between the 2012-2013 season to the 2023-2024 season for Women's College Basketball. Caitlin Clark's 13.8 WAR last season is the highest among any DI player, men's or women's, between the 2012-13 and 2023-24 seasons. If Iowa, who went 34-5 and were runners-up in the NCAA Tournament in 2023-24, had to replace Clark with a replacement-level player in Division I for the entire season, it would likely finish with 13 or 14 fewer wins, assuming average opponents. Now, the Hawkeyes would likely have replaced Clark with someone above a replacement level, but it is likely that they do not make it to the championship game without her. Anyone that has watched her knows how valuable she was to Iowa and how she was better than anyone on the court, using the WCBK WAR, as described above, illustrates just how valuable she really was.

It may not come as any surprise that the list is dominated by Geno Auriemma's best. Between 2012-13 and 2023-24, 14 of the top 25 in WAR played as a Huskie. UConn has a 442-33 (0.925) record in those seasons, by far the best in Division I, men's or women's. Stewart, Mosqueda-Lewis, and Faris led their teams to national titles, with Stewart leading undefeated teams in both 2013-14 and 2015-16.

The WAR metric may be used in college basketball to highlight key players entering and during the NCAA Tournament. WAR may additionally include conference-specific WAR metrics, adding DRIP for college basketball players, and extending WAR further historically.

FIGS. 10A and 10B illustrate additional DRIP values for multiple players, according to one or more embodiments, as described above. FIGS. 10A and 10B display graphs 1002, 1004 including a calculated DRIPs 1012, 1014 predicted for the first play and second player of FIG. 6 by implementing the techniques described herein. These DRIP values may be matched against a set of other players.

FIG. 11 illustrates an exemplary snapshot 1100 of the player tracking and markings detected from the broadcast tracking system, according to one or more embodiments. The snapshot 1100 may be of exemplary tracking data generated based on broadcast data as described in step 304 above. The chart 1102 may show at an exemplary frame from broadcast footage and the determined x,y position of a set of players in the exemplary frame, while the graph 1104 may show the output of the merge operation (as discussed above), with play-by-play data/event data corresponding to the tracking data. As shown in FIG. 11, the shot clock may be at 10.73 and the frame may correspond to Frame 804950 in accordance with a first framing scheme and frame 8874 in accordance with a second framing scheme. The tracking data shown in FIG. 11 may identify digital representations of players and/or objects (e.g., in a machine readable format) and may identify players and/or objects using reference numbers for these digital representations including reference numbers 1350849, 329480, 3357, 400602, 1373350, 469453, 639274, 1372251, 1373350, and 1437526.

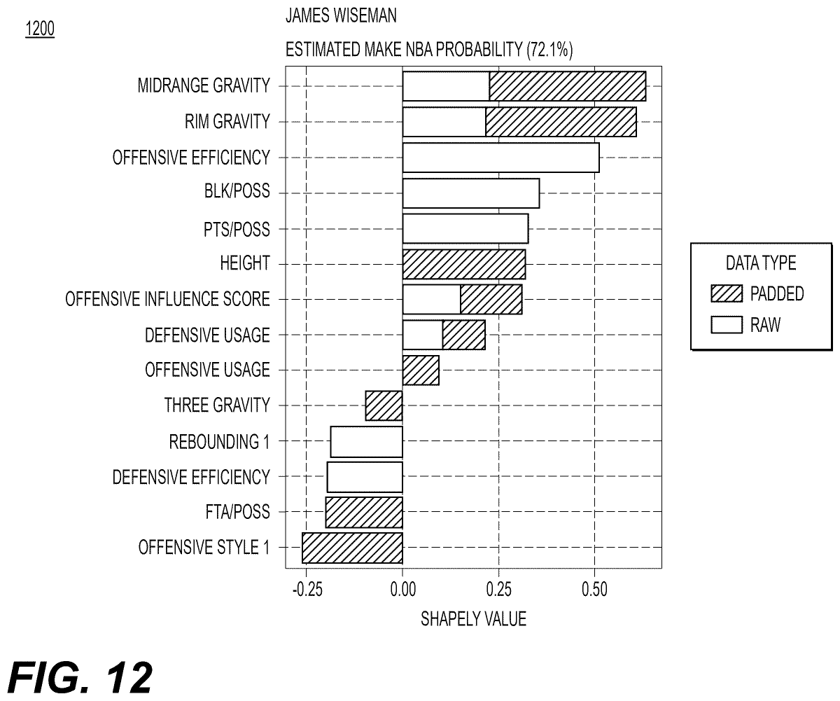

FIG. 12 illustrates an exemplary chart 1200 corresponding to the Shapley values generated for Player A using raw data and padded data, according to example embodiments. The chart 1200 may be based on applying the models of FIG. 2A. As shown, Player A may correspond to James Wiseman, who was drafted #2 overall by the Golden State Warriors in the 2021 NBA Draft. Wiseman may be a particularly interesting case because he only played a total of three games (69 minutes) in his college career. Looking at the raw data model, features such as points per possession (PTS/Poss) and blocks per possession (BLK/Poss) show very strongly as positive indicators of making the NBA. However, without their regressed versions (shown with dashed fill), which would show up as a stacked bar. Unsurprisingly, the padded data has regressed a three-game sample very heavily and reduced the quality of his raw scoring and block output. Non-regressed features, such as Rim Gravity and Midrange Gravity (both metrics of spatially weighted offensive efficiency and usage) show strongly positive in both the raw and padded data sets. Wiseman is a good example of not blindly adhering to model output. The model does not know why he only played three games, but when the padded and strongly regressed data are ensembled, the prediction is a lower probability of making the NBA compared to what would be expected based on known contextual information about his career.

It is important to note that the values are not outputs from the final ensemble but are instead the outputs of the two primary sub-models of the ensemble, i.e., the first set of models 201 and the second set of models 203.

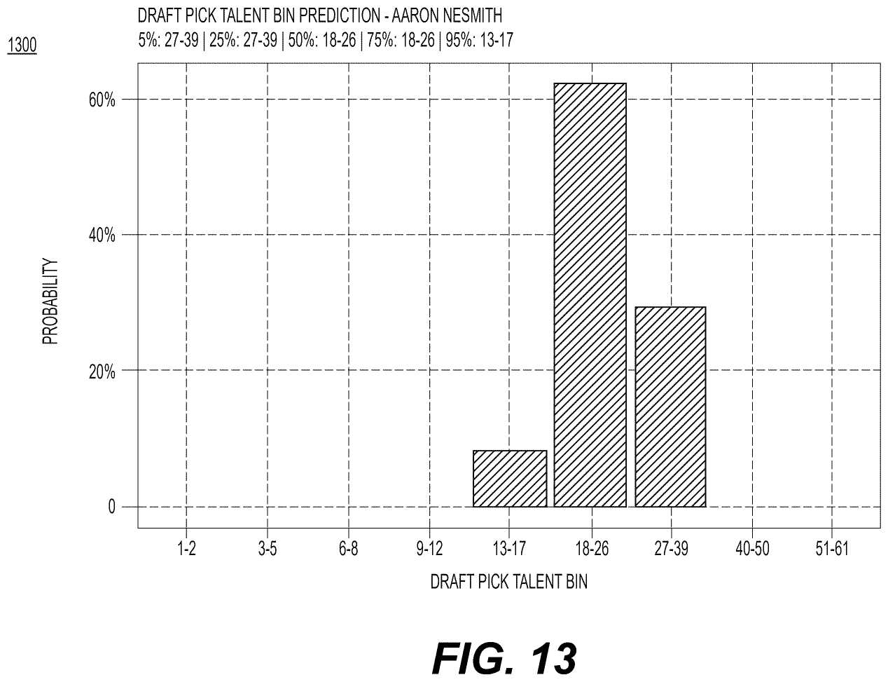

FIG. 13 illustrates an exemplary chart 1300 corresponding to a draft talent bin prediction for Player B, according to example embodiments. The chart 1300 may be an exemplary output of the draft pick model 225 as described above in the method of flowchart 300 of FIG. 3. FIG. 13 illustrates how an example output from the draft pick model may be a percentage chance of a draft pick occurring for a particular bin.

As shown, Player B may correspond to Aaron Nesmith. Prediction system 124 may provide that Nesmith has approximately a 62% chance of having the statistical profile of a player picked in the 18-26 range historically. As this does not include any NBA or pre-draft rankings, the output from prediction system 124 is not predicting where a player will be taken, only what range of player to which they are similar.

While prediction system 124 does not actually attempt to answer the question of how good Player B will be, there is some semblance of a quality gradient under the assumption that early picks are usually better NBA players than later picks.

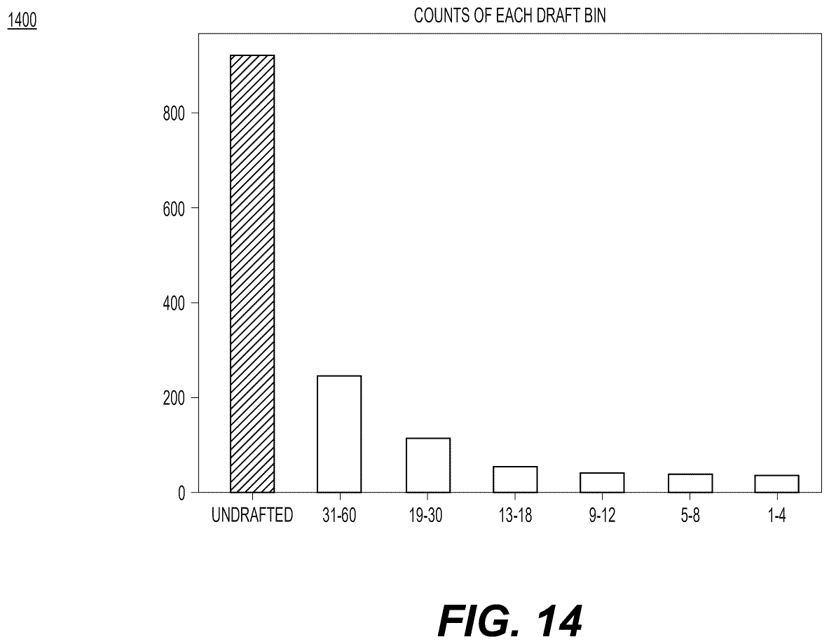

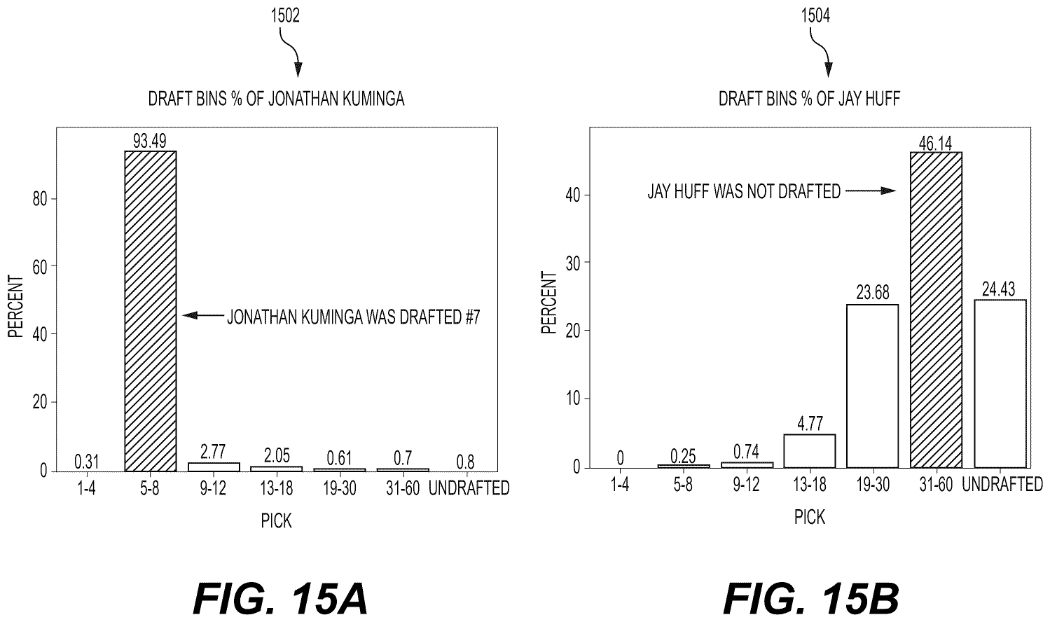

FIG. 14 illustrates a graph 1400 of an exemplary distribution of observations for each class and each set of bins, according to one or more embodiments. For example, this may correspond to a distribution of outputs from the draft pick model 225 of FIG. 2B. FIGS. 15A and 15B illustrates exemplary drafting prediction graphs 1502, 1504, according to one or more embodiments. These graphs may display predicted outputs of the draft pick model 225 of FIG. 2B for exemplary players. FIG. 15A may display that player Jonathan Kuminga has a 93.49% chance of being drafted in picks 5-8. This player was drafted in this bin, showing the accuracy of the model. FIG. 15B may show that Jay Huff was predicted as being drafted in the last bin but was actually originally undrafted. However, Jay Huff ended up playing in the NBA, indicating that the predictions may have been valuable and may indicate a more accurate position that the player should have been drafted.

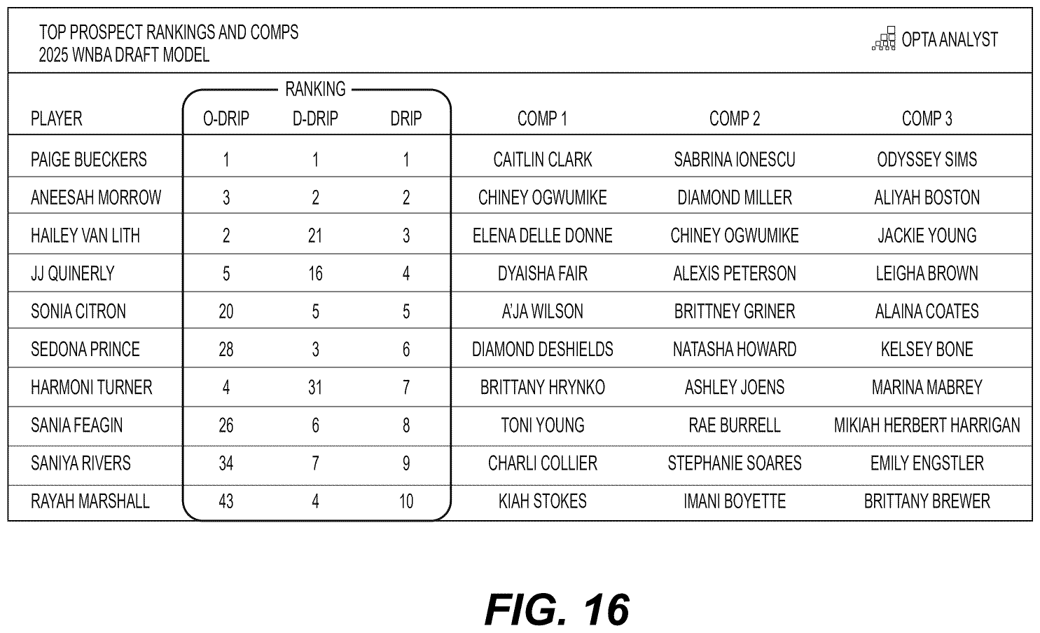

FIG. 16 illustrates an exemplary output 1600 of DRIP values expressed as DRIP ratings, where the highest DRIP value is DRIP rating 1, the second highest DRIP value is DRIP rating 2, etc. There are offensive DRIP ratings, defensive DRIP ratings, and total DRIP ratings. The total DRIP ratings are used to model potential draft positions for a plurality of women's CBK players (i.e., the potential class of 2025). Each player is associated with three comparison players (i.e., Comp 1, Comp 2, Comp 3) that had similar DRIP values to each player before the comparison players were drafted. For example, Paige Bueckers has similar DRIP values to Caitlin Clark, Sabrina Ionescu, and Odyssey Sims before they were drafted.

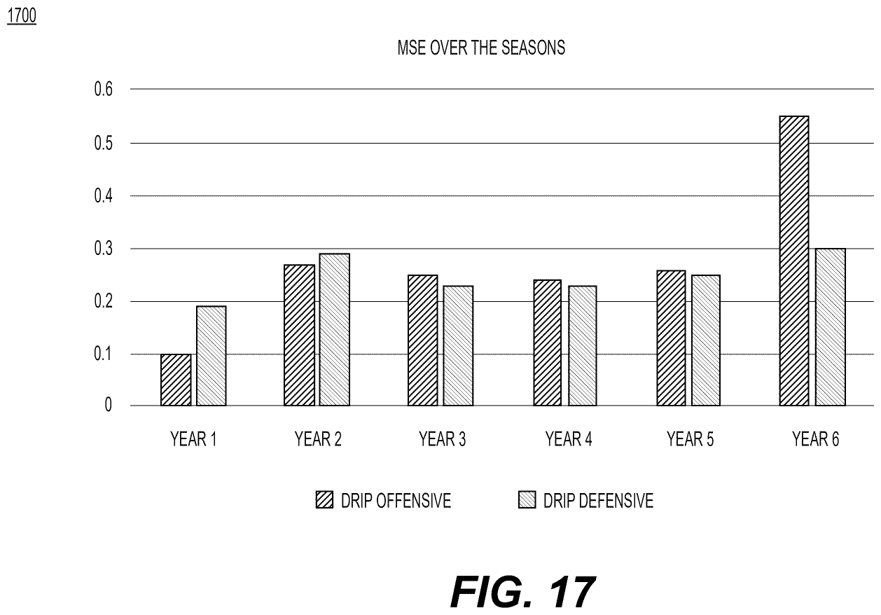

FIG. 17 illustrates an exemplary bar chart 1700 that tracks the mean square error (“MSE”) for offensive and defensive DRIP values, according to one or more embodiments. This may correspond to exemplary outputs of predictions (e.g., player prediction generated in FIG. 3) by implementing the techniques discussed herein. As discussed above, predictions may be generated for each of the first six seasons in a second league.

For comparison, when applying the three-step process on the box score data, the data may end up including the 25 box score features and the weighted sum features. FIG. 18 illustrates a line graph 1800 that tracks the R2 score for an offensive DRIP, according to one or more embodiments.

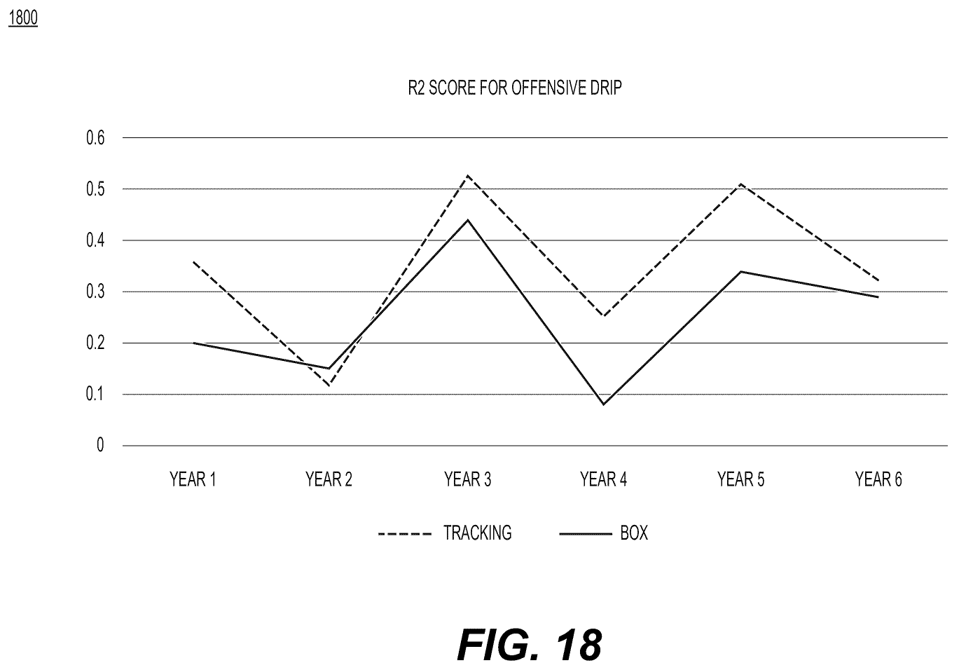

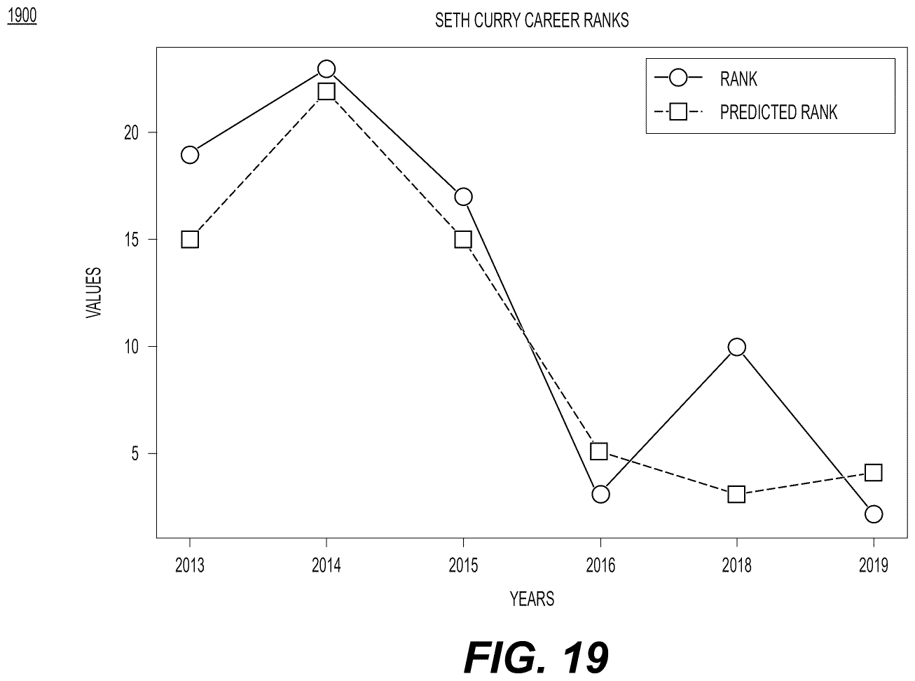

To visualize the players predicted in the model, the Offensive DRIP values may be ranked within the player's start season. The predicted rank may be based on the predicted DRIP and the actual rank may be based on the player's true DRIP. This may put into perspective where a player may size up against the player's fellow players. FIG. 19 illustrates a graph 1900 of a player's career ranks based on the defensive DRIP and how the model performed, according to one or more embodiments. As shown in FIG. 19, Seth Curry was predicted to do better as his career went on unfortunately, he got injured in his 5th season making him miss that year.

International players have become a huge contender in the basketball world and will only continue to become more prevalent. With broadcast tracking data creating a wealth of information for players born not only in the United States, sophisticated machine-learning techniques are more applicable. Random Forests, Neural Networks, feature reduction techniques, and/or data manipulation may be utilized to predict future player rankings in the NBA. It may allow for a team to see how a player could progress into an All-Star or fall flat. This may be beneficial to an NBA team looking for hidden talent across the globe. Future work could extend the multiplier to become more robust from league to league.

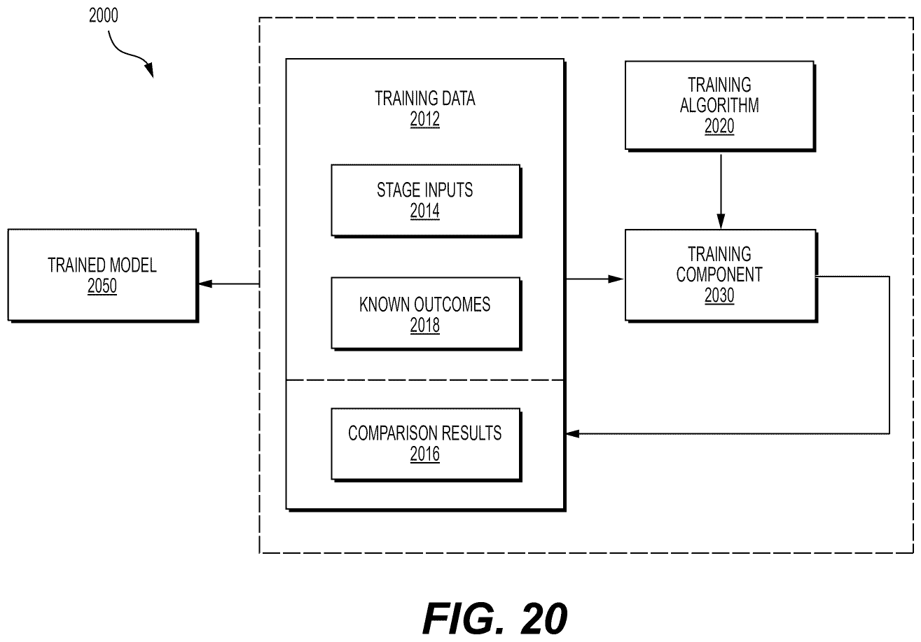

FIG. 20 depicts a flow diagram for training a machine learning model, in accordance with an aspect of the disclosed subject matter. As shown in flow diagram 2000 of FIG. 20, training data 2012 may include one or more of stage inputs 2014 and known outcomes 2018 related to a machine learning model to be trained. The stage inputs 2014 may be from any applicable source including a component or set shown in the figures provided herein. The known outcomes 2018 may be included for machine learning models generated based on supervised or semi-supervised training. An unsupervised machine learning model might not be trained using known outcomes 2018. Known outcomes 2018 may include known or desired outputs for future inputs similar to or in the same category as stage inputs 2014 that do not have corresponding known outputs.

The training data 2012 and a training algorithm 2020 may be provided to a training component 2030 that may apply the training data 2012 to the training algorithm 2020 to generate a trained machine learning model 2050. According to an implementation, the training component 2030 may be provided comparison results 2016 that compare a previous output of the corresponding machine learning model to apply the previous result to re-train the machine learning model. The comparison results 2016 may be used by the training component 2030 to update the corresponding machine learning model. The training algorithm 2020 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 2000 may be a trained machine learning model 2050.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

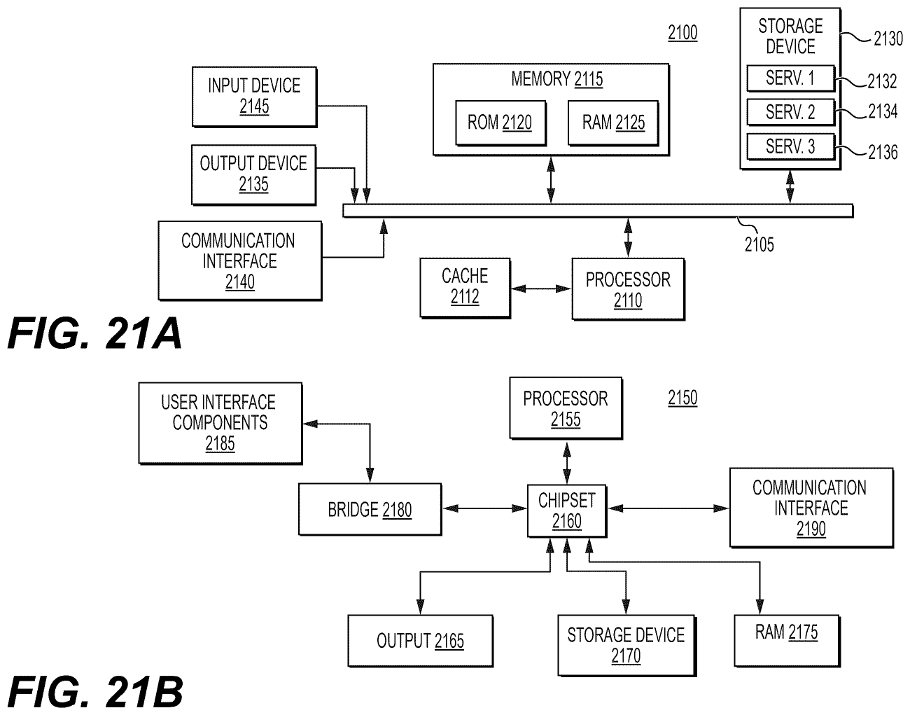

FIG. 21A illustrates an architecture of computing system 2100, according to example embodiments. System 2100 may be representative of at least a portion of organization computing system 104. One or more components of system 2100 may be in electrical communication with each other using a bus 2105. System 2100 may include a processing unit (CPU or processor) 2110 and a system bus 2105 that couples various system components including the system memory 2115, such as read only memory (ROM) 2120 and random access memory (RAM) 2125, to processor 2110. System 2100 may include a cache of high-speed memory connected directly with, in close proximity to, or integrated as part of processor 2110. System 2100 may copy data from memory 2115 and/or storage device 2130 to cache 2112 for quick access by processor 2110. In this way, cache 2112 may provide a performance boost that avoids processor 2110 delays while waiting for data. These and other modules may control or be configured to control processor 2110 to perform various actions. Other system memory 2115 may be available for use as well. Memory 2115 may include multiple different types of memory with different performance characteristics. Processor 2110 may include any general purpose processor and a hardware module or software module, such as service 1 2132, service 2 2134, and service 3 2136 stored in storage device 2130, configured to control processor 2110 as well as a special-purpose processor where software instructions are incorporated into the actual processor design. Processor 2110 may essentially be a completely self-contained computing system, containing multiple cores or processors, a bus, memory controller, cache, etc. A multi-core processor may be symmetric or asymmetric.

To enable user interaction with the computing system 2100, an input device 2145 may represent any number of input mechanisms, such as a microphone for speech, a touch-sensitive screen for gesture or graphical input, keyboard, mouse, motion input, speech and so forth. An output device 2135 (e.g., display) may also be one or more of a number of output mechanisms known to those of skill in the art. In some instances, multimodal systems may enable a user to provide multiple types of input to communicate with computing system 2100. Communications interface 2140 may generally govern and manage the user input and system output. There is no restriction on operating on any particular hardware arrangement and therefore the basic features here may easily be substituted for improved hardware or firmware arrangements as they are developed.

Storage device 2130 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 2125, read only memory (ROM) 2120, and hybrids thereof.

Storage device 2130 may include services 2132, 2134, and 2136 for controlling the processor 2110. Other hardware or software modules are contemplated. Storage device 2130 may be connected to system bus 2105. In one aspect, a hardware module that performs a particular function may include the software component stored in a computer-readable medium in connection with the necessary hardware components, such as processor 2110, bus 2105, output device 2135, and so forth, to carry out the function.

FIG. 21B illustrates a computer system 2150 having a chipset architecture that may represent at least a portion of organization computing system 104. Computer system 2150 may be an example of computer hardware, software, and firmware that may be used to implement the disclosed technology. System 2150 may include a processor 2155, representative of any number of physically and/or logically distinct resources capable of executing software, firmware, and hardware configured to perform identified computations. Processor 2155 may communicate with a chipset 2160 that may control input to and output from processor 2155. In this example, chipset 2160 outputs information to output 2165, such as a display, and may read and write information to storage device 2170, which may include magnetic media, and solid-state media, for example. Chipset 2160 may also read data from and write data to RAM 2175. A bridge 2180 for interfacing with a variety of user interface components 2185 may be provided for interfacing with chipset 2160. Such user interface components 2185 may include a keyboard, a microphone, touch detection and processing circuitry, a pointing device, such as a mouse, and so on. In general, inputs to system 2150 may come from any of a variety of sources, machine generated and/or human generated.

Chipset 2160 may also interface with one or more communication interfaces 2190 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine by processor 2155 analyzing data stored in storage device 2170 or RAM 2175. Further, the machine may receive inputs from a user through user interface components 2185 and execute appropriate functions, such as browsing functions by interpreting these inputs using processor 2155.

It may be appreciated that example systems 2100 and 2150 may have more than one processor 2110 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for utilizing tracking data to predict a player rating, the method comprising:
receiving broadcast data for a plurality of games in a first league, the plurality of games including a first player;
generating tracking data for each of the plurality of games, the tracking data comprising coordinates of player positions and ball positions for each frame of the broadcast data;
receiving play-by-play data for each of the plurality of games, the play-by-play data describing events that occur within the plurality of games;
merging the tracking data and play-by-play data to generate a set of input features; and
predicting, based on the set of input features, a player rating for the first player, the player rating being indicative of a predicted level of performance in a second league.

2. The method of claim 1, further comprising:
receiving box score data for the plurality of games in the first league; and
merging the box score data with the tracking data and play-by-play data to generate the set of input features.

3. The method of claim 2, further comprising:
applying a multiplier to the box score data based on the first league, wherein the multiplier is based on the first league and particular year of the first player playing in the first league.

4. The method of claim 1, further comprising:
incorporating biographical data for the first player into the set of input features, wherein the biographical data includes age, height, and weight of the first player.

5. The method of claim 1, wherein merging the play-by-play data for each of the plurality of games with the tracking data of the plurality of games to generate the set of input features comprises:
combining the play-by-play data with optical character recognition data, the coordinates of player positions and ball positions using a fuzzy matching algorithm.

6. The method of claim 1, further comprising:
reducing random noise in the set of input features by creating new player representations using mean-regression.

7. The method of claim 1, further comprising:
predicting, by applying a first random forest classification algorithm, a classification for the first player, the classification being a prediction of whether the first player will be drafted in the second league; and
incorporating the classification for the first player into the set of input features.

8. The method of claim 1, further comprising:
predicting, by applying an artificial neural network, a bin from a plurality of bins, wherein the plurality of bins represent sets of draft picks in the second league; and
incorporating the predicted bin into the set of input features.

9. The method of claim 8, wherein applying the artificial neural network comprises:
applying a Relu and softmax activation function;
applying an Adam optimizer; and
applying categorical cross entropy loss to the set of input features to predict the bin of the first player.

10. The method of claim 1, wherein predicting, based on the set of input features, the player rating for the first player comprises:
predicting a collection of player ratings for the first player, each of the collection of player rating being for a separate year of the first player in the second league.

11. The method of claim 1, wherein predicting, based on the set of input features, the player rating for the first player, includes: applying a second random forest algorithm to the set of input features.

12. A system for utilizing tracking data to predict a player rating, the system comprising:
a memory configured to store processor-readable instructions; and
a processor operatively connected to the memory, and configured to execute the instructions to perform operations comprising:
receiving broadcast data for a plurality of games in a first league, the plurality of games including a first player;
generating tracking data for each of the plurality of games, the tracking data comprising coordinates of player positions and ball positions for each frame of the broadcast data;
receiving play-by-play data for each of the plurality of games, the play-by-play data describing events that occur within the plurality of games;
merging the tracking data and play-by-play data to generate a set of input features; and
predicting, based on the set of input features, a player rating for the first player, the player rating being indicative of a predicted level of performance in a second league.

13. The system of claim 12, wherein the operations further comprise:
receiving box score data for the plurality of games in the first league; and
merging the box score data with the tracking data and play-by-play data to generate the set of input features.

14. The system of claim 13, wherein the operations further comprise:
applying a multiplier to the box score data based on the first league, wherein the multiplier is based on the first league and particular year of the first player playing in the first league.

15. The system of claim 12, wherein the operations further comprise:
incorporating biographical data for the first player into the set of input features, wherein the biographical data includes age, height, and weight of the first player.

16. A method for determining a performance rating of a target player, the method comprising:
identifying, by a computing system, the target player;
receiving broadcast data for a plurality of game, the plurality of games including the target player;
generating tracking data for each of the plurality of games, the tracking data comprising coordinates of a position of the target player and ball positions for each frame of the broadcast data;
receiving play-by-play data for each of the plurality of games, the play-by-play data describing events related to the target player that occur within the plurality of games;
generating, by the computing system, time series data points for the target player based on the tracking data and play-by-play data of the target player;
providing, by the computing system, an input including the time series data points to a first player prediction model and a second player prediction model, wherein the first and the second player prediction models are trained to find associations between the first game data of a plurality of other players and the time series data points of the target player and output a next game projection for the target player;
generating, by the first and second player prediction models, the next game projection for the target player;
generating, by the computing system, an adjustment weighting, wherein the adjustment weighting is based on a comparison of the next game projection for the target player with an average statistic for the target player;
providing, by the computing system, the adjustment weighting to the first and the second player prediction models as training data; and
training, by the computing system, the first and the second player prediction models using the training data.

17. The method of claim 16, wherein the method further comprises:
comparing, by the computing system, the next game projection for the target player to actual statistics of the target player;
determining, by the computing system, that the next game projection for the target player differs from the actual statistics by at least a threshold amount in one category of statistics; and
based on the determining, adjusting, by the computing system, the next game projection.

18. The method of claim 16, wherein the generating, by the computing system, the first game data for the target player based on characteristics of the target player comprises:
generating an adjusted game one metric for each statistical category based at least in part on attributes of the target player, the attributes comprising one or more of a height, a weight, an age, and a draft pick number.

19. The method of claim 16, wherein generating, by the computing system, the time series data points for the target player based on at least one of the first game data of the target player comprises:
padding the at least one of the first game data of the target player with league average data.

20. The method of claim 19, wherein the method further comprises:
generating a baseline value for each statistic using a bayes filter based on the padded first game data.
